(19) United States
(12) Patent Application Publication
(10) Pub. No.: US 2023/0224904 A1
(43) Pub. Date: Jul. 13, 2023

(54) MEASURING UPLINK LATENCY

(71) Applicant: QUALCOMM Incorporated, San Diego, CA (US)

(72) Inventors: Mickael MONDET, Louannec (FR); Prashanth Haridas HANDE, San Diego, CA (US); Ravi AGARWAL, San Diego, CA (US); Peerapol TINNAKORNSRISUPHAP, San Diego, CA (US)

(21) Appl. No.: 17/647,956

(22) Filed: Jan. 13, 2022

(51) Int. Cl. H04W 72/12

(52) U.S. Cl. CPC H04W 72/1284; H04W 72/1231

(57) ABSTRACT

A user equipment (UE) may receive, at a packet data convergence protocol (PDCP) layer, a service data unit (SDU) including uplink (UL) data to be transmitted to a base station, and transmit, to the base station, at least one UL transmission including the UL data and timing information associated with an arrival of the SDU at the PDCP layer. The base station may receive the at least one UL transmission including the UL data, identify timing information, and calculate an UL delay based at least in part on the timing information from the UE. The timing information may be communicated in at least one of a PDCP protocol data unit (PDU) header or a medium access control (MAC) control element (CE) (MAC-CE).

### TECHNICAL FIELD

The present disclosure relates generally to communication systems, and more particularly, to a method of wireless communication including measuring uplink airlink latency.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE) and a base station. The UE may receive, at a packet data convergence protocol (PDCP) layer, a service data unit (SDU) including uplink (UL) data to be transmitted to the base station, and transmit, to the base station, at least one UL transmission including the UL data and timing information associated with an arrival of the SDU at the PDCP layer. The base station may receive the at least one UL transmission including the UL data, identify timing information, and calculate an UL delay based at least in part on the timing information from the UE. The timing information may be communicated in at least one of a PDCP protocol data unit (PDU) header or a medium access control (MAC) control element (CE) (MAC-CE). The timing information may include at least one of, but not limited to, an arrival time associated with the arrival of the SDU at the PDCP layer, a transmission time associated with transmitting a first MAC PDU containing UL data of the SDU, a first wait time between an arrival time associated with the arrival of the SDU at the PDCP layer and the transmission time, or a second wait time between the arrival time associated with the arrival of the SDU at the PDCP layer and a time associated with building the PDCP PDU header.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4A is a diagram illustrating an example of delay of a method of wireless communication, in accordance with various aspects of the present disclosure.

FIG. 4B is a diagram illustrating an example of delay of a method of wireless communication, in accordance with various aspects of the present disclosure.

FIG. 5 is a call-flow chart of a method of wireless communication, in accordance with various aspects of the present disclosure.

FIG. 6 is a call-flow chart of a method of wireless communication, in accordance with various aspects of the present disclosure.

FIG. 7 is a call-flow chart of a method of wireless communication, in accordance with various aspects of the present disclosure.

FIG. 8 is a call-flow chart of a method of wireless communication, in accordance with various aspects of the present disclosure.

FIG. 9 is a call-flow chart of a method of wireless communication, in accordance with various aspects of the present disclosure.

FIG. 10 is a call-flow chart of a method of wireless communication, in accordance with various aspects of the present disclosure.

FIG. 11 is a call-flow chart of a method of wireless communication, in accordance with various aspects of the present disclosure.

FIG. 12 is a call-flow chart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a flowchart of a method of wireless communication, in accordance with various aspects of the present disclosure.

FIG. 17 is a diagram illustrating an example of a hardware implementation for an example apparatus, in accordance with various aspects of the present disclosure.

FIG. 18 is a diagram illustrating an example of a hardware implementation for an example apparatus, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components, end-user devices, etc. of varying sizes, shapes, and constitution.

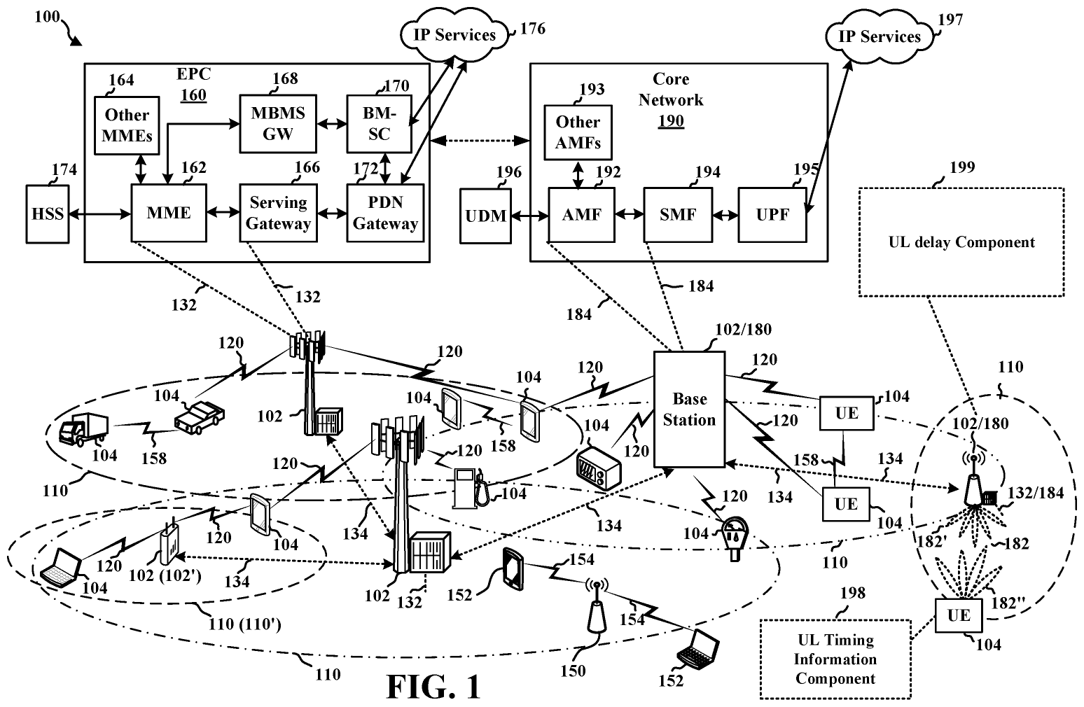

FIG. 1 is a diagram illustrating an example of a wireless communications system and an access network 100. The wireless communications system (also referred to as a wireless wide area network (WWAN)) includes base stations 102, UEs 108, an Evolved Packet Core (EPC) 160, and another core network 190 (e.g., a 5G Core (5 GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 108. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 108 may include uplink (UL) (also referred to as reverse link) transmissions from a UE 108 to a base station 102 and/or downlink (DL) (also referred to as forward link) transmissions from a base station 102 to a UE 108. The communication links 120 may use multiple-input and multiple-output (MIMO) antenna technology, including spatial multiplexing, beamforming, and/or transmit diversity. The communication links may be through one or more carriers. The base stations 102/UEs 108 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 108 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (4 10 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 108. When the gNB 180 operates in millimeter wave or near millimeter wave frequencies, the gNB 180 may be referred to as a millimeter wave base station. The millimeter wave base station 180 may utilize beamforming 182 with the UE 108 to compensate for the path loss and short range. The base station 180 and the UE 108 may each include a plurality of antennas, such as antenna elements, antenna panels, and/or antenna arrays to facilitate the beamforming.

The base station 180 may transmit a beamformed signal to the UE 108 in one or more transmit directions 182′. The UE 108 may receive the beamformed signal from the base station 180 in one or more receive directions 182″. The UE 108 may also transmit a beamformed signal to the base station 180 in one or more transmit directions. The base station 180 may receive the beamformed signal from the UE 108 in one or more receive directions. The base station 180/UE 108 may perform beam training to determine the best receive and transmit directions for each of the base station 180/UE 108. The transmit and receive directions for the base station 180 may or may not be the same. The transmit and receive directions for the UE 108 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 108 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 108 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 108. Examples of UEs 108 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 108 may be referred to as IoT devices (e.g., parking meter, gas pump, toaster, vehicles, heart monitor, etc.). The UE 108 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 108 may include an UL timing information component 198 configured to receive an SDU at a PDCP layer, the SDU including UL data to be transmitted in a PDU, and transmit, to a base station, at least one UL transmission including the UL data and timing information associated with an arrival of the SDU at the PDCP layer. In certain aspects, the base station 180 may include an UL delay component 199 configured to receive, from a UE, at least one UL transmission including an UL data, identify timing information associated with a SDU arriving at a PDCP layer of the UE, the SDU associated with the UL data, and calculate an UL delay based at least in part on the timing information from the UE. Although the following description may be focused on 5G NR, the concepts described herein may be applicable to other similar areas, such as LTE, LTE-A, CDMA, GSM, and other wireless technologies.

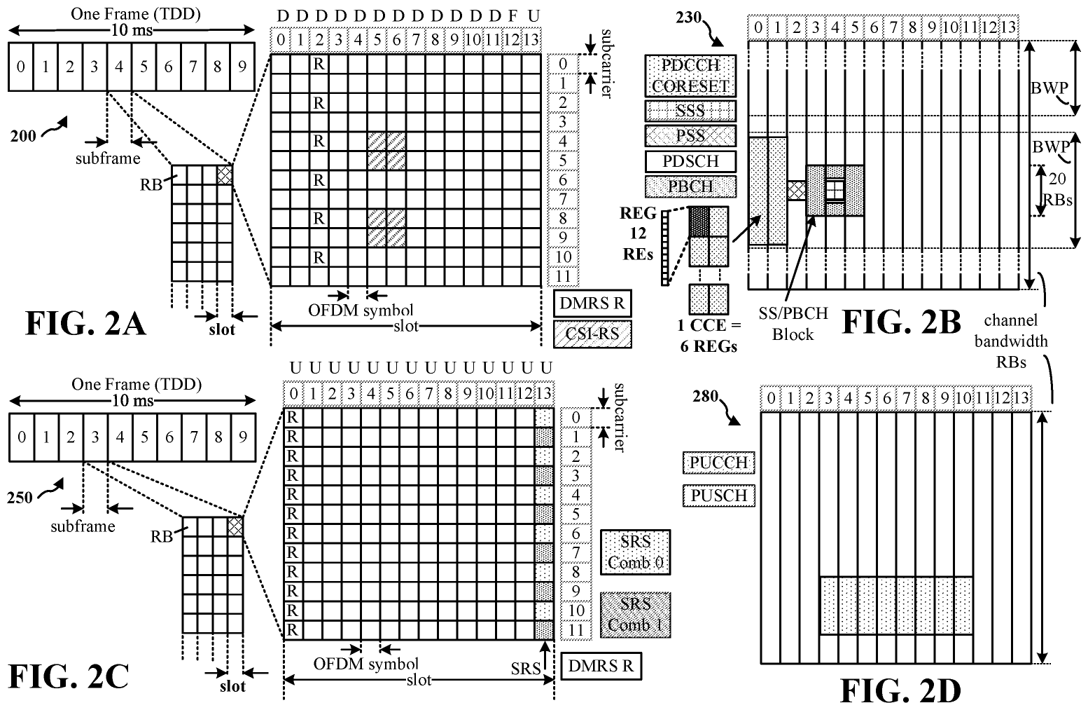

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2^{μ} slots/subframe. The subcarrier spacing may be equal to 2*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 108 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

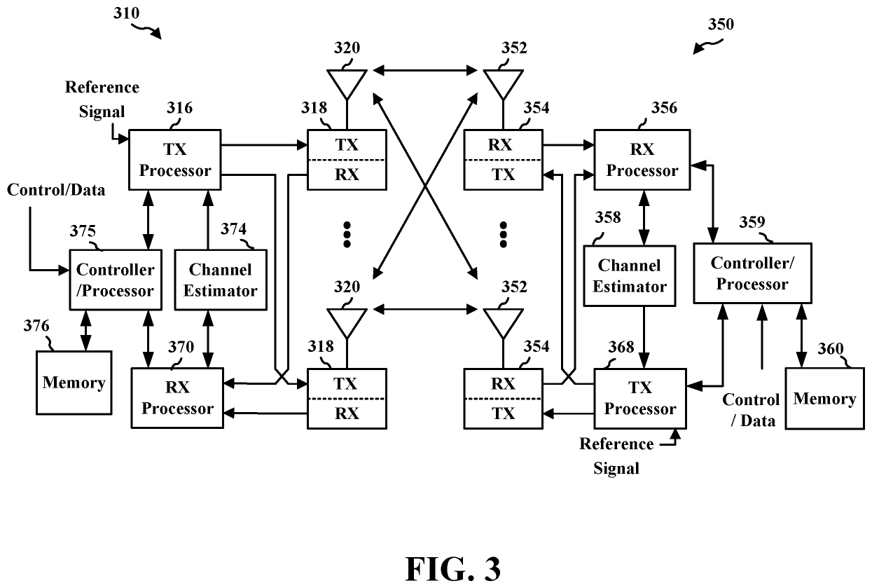

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. At least one of the TX processor 316, the RX processor 370, and the controller/processor 375 may be configured to perform aspects in connection with 199 of FIG. 1.

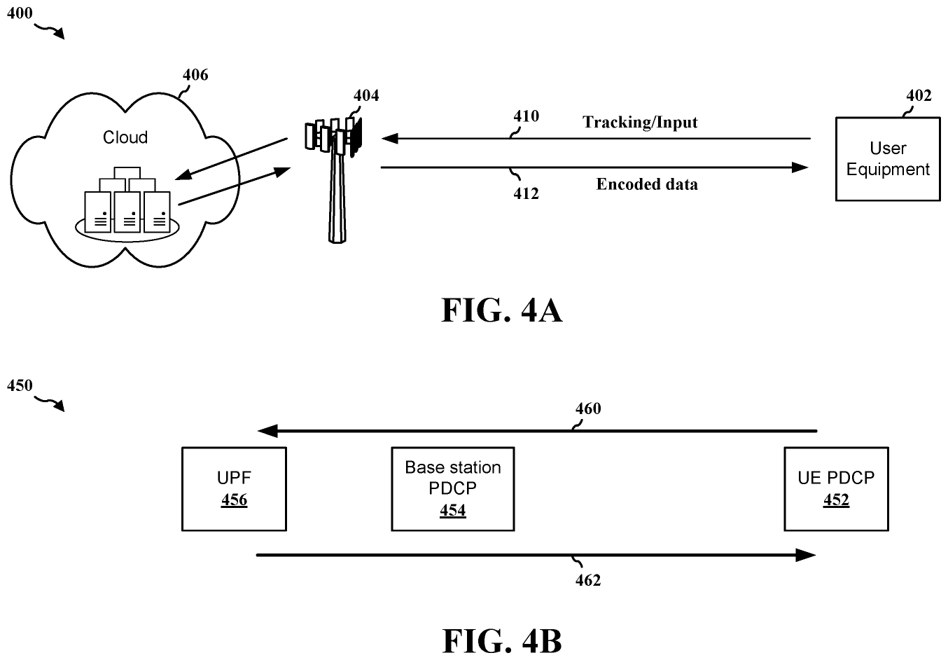

FIG. 4A is a diagram 400 illustrating an example of delay of a method of wireless communication. The diagram 400 may include a user equipment (UE) 402, a base station 404, and a cloud server 406. In some aspects, the service provided to the UE 402 may be associated with a low latency traffic. In one example, the UE and the base station may be configured to provide an extended reality (XR) service or a cloud gaming service, and the associated traffic may be associated with a low latency. Accordingly, the uplink (UL) packet 410 may include input information associated with the service provided to the UE 402. That is, the UL packet 410 may include a tracking/pose information for the XR service or inputs for the cloud gaming service, and in some examples, the UL packet 410 may include data of 100 bytes every 2 ms (at 500 Hz). The cloud server 406 may receive the UL packet 410 and generate the downlink (DL) packet 412 based on the received UL packet 410. For example, the cloud server 406 may receive the UL packet 410 including the tracking/pose information for the XR service or inputs for the cloud gaming service, and generate the DL packet 412 based on the received UL packet 410 including the tracking/pose information for the XR service or inputs for the cloud gaming service.

The DL packet 412 may include an encoded data associated with the service provided to the UE. For example, the encoded data may include data of over 100 kilobytes at 45, 60, 75, or 90 frames per second (fps), i.e., every 22, 16, 13, or 11 milliseconds. In case the XR service or the cloud gaming service is provided from a cloud server, the DL packet 412 may include a quasi-periodic encoded video with burst frame every 1/fps seconds or two, possibly staggered, “eye-buffers” (or images) per frame every 1/2*fps seconds. In case the UE is provided with the cloud gaming service, the DL packet 412 may include a quasi-periodic encoded video with burst frame every 1/fps seconds. In case the UE is provided with the XR service, the DL packet 412 may include a quasi-periodic encoded video with separate images, staggered or simultaneously, for each eye per frame every 1/2*fps seconds.

In some aspects, the latency observed from the UE 402 may be associated with a round-trip time (RTT) between transmitting the UL packet 410 and receiving the DL packet 412. That is, the network latency experienced at the UE 402 may be determined based on a RTT between transmitting the UL packet 410 including the tracking/pose information for the XR service or the inputs for the cloud gaming service and receiving the DL packet including the encoded data associated with the service provided to the UE 402. In one example, the network latency at the UE 402 may be configured as the time between transmitting the UL packet 410 including the input information associated with the service provided to the UE 402 and receiving the encoded data associated with the service provided to the UE, the encoded data including a quasi-periodic encoded video with burst frame every

$$\frac{1}{f p s}$$

seconds or two, possibly staggered, “eye-buffers” (or images) per frame every

$$\frac{1}{2 * f p s}$$

seconds. For example, the wireless network may be configured to have the RTT less than or equal to 20 ms to support the input information associated with the service provided to the UE 402.

FIG. 4B is a diagram 450 illustrating an example of delay of a method of wireless communication. The diagram 450 may include a UE PDCP layer 452 of a UE, base station PDCP layer 454 of a base station, and a UPF 456 in a core network. In some aspects, the base station may consider the RTT of the wireless communication as a quality of service (QoS) metric. That is, the base station may use the RTT as the metric of the QoS, and the base station may determine the wireless communication configuration based on the measured RTT.

In one aspect, the base station may compare the RTT of the wireless communication to at least one threshold value associated with the corresponding QoS to determine whether the current wireless communication meets a condition specified for the corresponding QoS. For example, the at least one threshold value may include a set of threshold values configured for different QoSs. In another aspect, the configuration of, or scheduling of, the wireless communication by the base station may be based on the measured RTT. For example, the base station may schedule at least one of the UL resources allocated for the UL data or the DL resources associated with the UL data based on the UL delay.

In some aspects, the RTT may include an UL packet delay 460 between the UE PDCP layer 452 and the UPF 456 through the base station PDCP layer 454 and a DL packet delay 462 between the UPF 456 and the UE PDCP layer 452 through the base station PDCP layer 454. Each of the UL packet delay 460 and the DL packet delay 462 may be broken down into two components, including an air interface delay between the UE PDCP layer 452 and the base station PDCP layer 454, and a network interfaces delay between the base station PDCP layer 454 and the UPF 456. Accordingly, the RTT of the wireless communication may be broken down into four components, including the UL air interface delay between the UE PDCP layer 452 and the base station PDCP layer 454, the UL network interfaces delay between the base station PDCP layer 454 and the UPF 456, the DL network interfaces delay between the UPF 456 and the base station PDCP layer 454, and the DL air interface delay between the base station PDCP layer 454 and the UE PDCP layer 452. In some aspects, the base station may calculate the UL air interface delay between the UE PDCP layer 452 and the base station PDCP layer 454.

At the UE's perspective, when a data packet arrives in the UE's PDCP queue, the time until it is being transmitted depends on several factors. That is, when an PDCP SDU including an UL data packet arrives at the UE's PDCP layer and in the UE's PDCP queue, there are multiple parameters that may affect the time/delay until the UL data packet is transmitted to the base station in an UL transmission. The several factors or the plurality of parameters may include, among other possibly factors, a delay until the next scheduling request transmission opportunity which may be associated with whether the UE's buffer was empty, a delay until the transmission of the BSR, a delay until the next available UL grant, or a logical channel prioritization. Here, the logical channel prioritization may refer to a set of procedures of determining the amount of data for each logical channel to be included in the MAC PDU based on the priority of each logical channel. That is, if there is data from logical channels with a higher priority and waiting for transmission, the UL data packet may not be transmitted in the next MAC PDU, due to the logical channel prioritization.

From the base station's perspective, the base station may not identify a delay within the UE's modem. Particularly, the base station may not measure the delay from the arrival of a SDU including a data packet at the UE's PDCP layer/queue to the start of the transmission of the data packet on the UL air interface. Aspects presented herein enable a more accurate understanding of the delay associated with a data packet and may allow for improved QoS, through the UE reporting, to the base station, timing information related to the arrival time of the SDU in the PDCP queue. That is, the UE may transmit, to the base station, the timing information associated with the arrival of the SDU at the PDCP layer, and the base station may calculate or measure the UL delay based at least in part on the timing information from the UE and manage the configuration of the wireless communication according to the UL delay.

Based on the UL delay calculated or measured based at least in part on the timing information from the UE, the network including the base station may monitor the wireless communication and manage the configuration of the wireless communication according to the UL delay.

In one aspect, the network including the base station may perform a QoS monitoring. That is, the network may use the UL delay to assess whether the QoS of the RTT sensitive traffic is fulfilled. The network including the base station may monitor the UL delay, and compare the UL delay with at least one monitoring threshold value associated with the corresponding traffic to determine whether the QoS of the corresponding traffic meets the condition specified for the corresponding traffic. For example, if the calculated UL delay is greater than a monitoring threshold value specified for the corresponding traffic, the base station may determine that the QoS of the traffic does not meet the specified condition to provide the service associated with the traffic.

In some aspects, the network including the base station may use the metric (e.g., UL delay) to adapt the UL resources (e.g. radio, hardware, or transport) or its scheduling decisions. That is, the network including the base station may configure or schedule and indicate the configuration of the UL resources based on the calculated UL delay. In one aspect, a long UL delay may indicate that the UL resources are undersized or that the cell is overloaded. That is, the network including the base station may increase the size of the UL resources allocated for the corresponding UE based on detecting a long UL delay. For example, the network including the base station may determine that the UL delay is greater than a monitoring threshold value corresponding to the QoS of the traffic, and the network may increase the size of the UL resources allocated for the corresponding UE based on determining that the UL delay is greater than the monitoring threshold value.

In another aspect, the base station may prioritize scheduling based on the UL delay. For example, some traffic, such as traffic associated with the XR, may be more sensitive to the Motion to Render to Photon (M2R2P) and RTT, and may be have higher importance over other traffics, e.g., higher priority. The base station downlink scheduler (e.g. a deadline-aware scheduler) may take advantage of the UL delay of an SDU (e.g., the traffic associated with the tracking/pose information in XR) to handle the priority of the associated downlink SDUs (e.g., the traffic associated with the video frame in XR) accordingly.

In some aspects, the UE may report, to the base station, timing information related to the arrival time of the SDU in the PDCP queue. That is, based on receiving the SDU including UL data to be transmitted in a PDU at the PDCP layer, the UE may report, to the base station, the timing information associated with the arrival of the SDU at the PDCP layer, and the base station may calculate or measure the UL delay based at least on the timing information received from the UE. Here, the timing information may include at least one of, but not limited to, an arrival time associated with the arrival of the SDU at the PDCP layer, a transmission time associated with transmitting a first MAC PDU containing UL data of the SDU, a first wait time between an arrival time associated with the arrival of the SDU at the PDCP layer and the transmission time, or a second wait time between the arrival time associated with the arrival of the SDU at the PDCP layer and a time associated with building the PDCP PDU header.

In some aspects, the UE may report the timing information through a PDCP signaling or a MAC signaling. That is, the UE may transmit the timing information in at least one of a PDCP PDU header or a MAC-CE. The UE may transmit, to the base station, at least one UL transmission including the UL data associated with the SDU arrived at the PDCP layer, and the timing information may be transmitted in at least one of the PDCP PDU header associated with the at least one UL transmission or the MAC-CE associated with the at least one UL transmission.

In one aspect, the timing information may be reported through PDCP signaling for QoS monitoring purpose, as the processing of the timing information is done after the reception of the UL SDU. That is, the base station may receive the timing information in the PDCP PDU header, process the timing information after receiving the UL SDU, and use the timing information to perform the QoS monitoring. In another aspect, the timing information may be reported through MAC signaling for scheduling decision purposes, as the timing information may be used by the downlink scheduler, ahead of the transmission of the DL SDU that is associated to the UL SDU the timing information refers for the scheduling decision purposes.

The two options, e.g., the PDCP signaling or the MAC signaling, for transmitting and receiving the timing information associated with the arrival time of the SDU in the PDCP queue of the UE may have increased significance in case the MAC layer and the PDCP layer are not hosted in the same location. In some example, the base station may have a distributed architecture, and the MAC layer and the PDCP layer may be hosted far from each other. For example, the base station may have a distributed architecture including a centralized unit (CU) including the PDCP layer and a distributed unit (DU) including MAC layer.

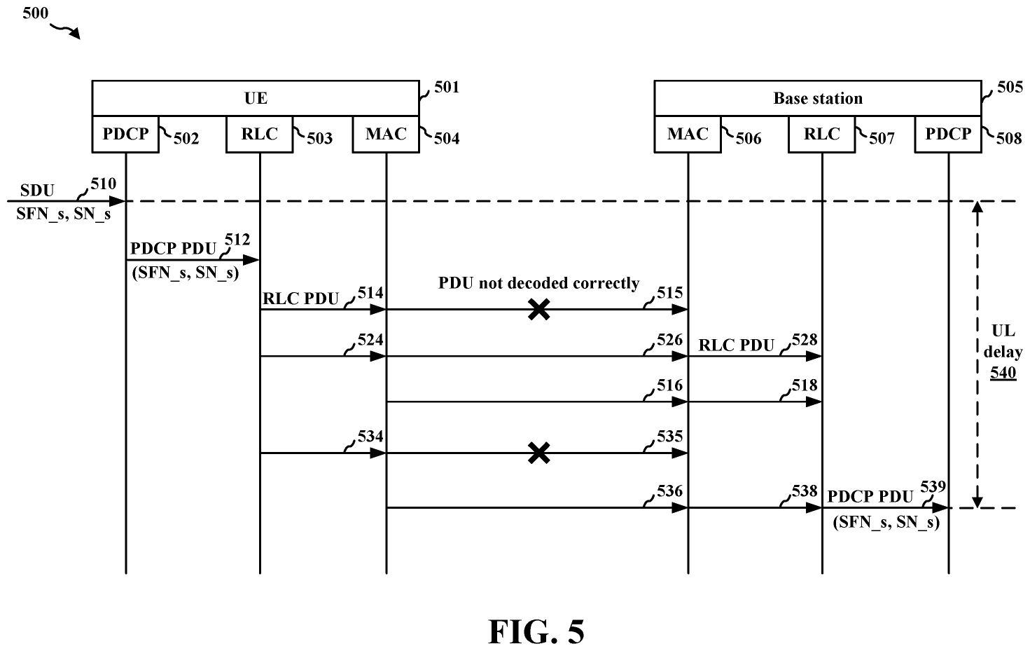

FIG. 5 is a call-flow chart of a method of wireless communication. The call-flow diagram 500 may include a UE 501 including a PDCP layer 502, an RLC layer 503, and a MAC layer 504, and a base station 505 including a MAC layer 506, an RLC layer 507, and a PDCP layer 508. In some aspects, the timing information may include an arrival time associated with the arrival of the SDU at the PDCP layer 502 of the UE 501, and the UE 501 may report the timing information to the base station using the PDCP signaling.

At 510, the UE 501 may receive the SDU from a higher layer, e.g., the application layer, including UL data to be transmitted to the base station 505. Here, the arrival time may indicate the arrival of the SDU at the PDCP layer 502 of the UE 501. In one example, the arrival time (SFN_s, SN_s) may indicate the arrival time that the SDU arrive at the PDCP layer 502 of the UE 501, where SFN_s is a system frame number and SN_s is a slot number of the system time that the SDU arrived at the PDCP layer 502 of the UE 501 from the higher layer of the UE.

At 512, a PDCP PDU may be transmitted from the PDCP layer 502 of the UE 501 to the RLC layer 503 of the UE 501. That is, the PDCP layer 502 of the UE 501 may generate the PDCP PDU based on the SDU received at 510 from the higher layer, and transmit the PDCP PDU to the RLC layer 503 of the UE 501.

Here, the PDCP layer 502 of the UE 501 may include, in the PDCP PDU transmitted at 512, the timing information including the arrival time associated with the arrival of the SDU at the PDCP layer 502 of the UE 501. That is, the PDCP layer 502 of the UE 501 may include the arrival time as the timing information in the PDCP PDU transmitted to the 512. The timing information may include the arrival time (SFN_s, SN_s) that the SDU arrives in the PDCP queue, and the PDCP layer 502 of the UE 501 may include the timing information in the PDCU PDU transmitted at 512. In one aspect, the PDCP layer 502 of the UE 501 may include the timing information in a header of the PDCP PDU transmitted at the 512. In one example, the header of the PDCP PDU transmitted at 512 may have a particular structure to carry the timing information.

The RLC layer 503 of the UE 501 may transmit at least one RLC PDU to the MAC layer 504 of the UE 501 based on the PDCP PDU received from the PDCP layer 502 of the UE 501. That is, the RLC layer 503 of the UE 501 may generate the at least one RLC PDU based on the PDCP PDU received from the PDCP layer 502 of the UE 501, and transmit the RLC PDU to the MAC layer 504 of the UE 501 for the MAC layer 504 of the UE 501. At 514, 524, and 534, the RLC layer 503 of the UE 501 may transmit at least one RLC PDU to the MAC layer 504 of the UE 501. At 514, the RLC layer 503 of the UE 501 may generate the first RLC PDU based on the PDCP PDU received from the PDCP layer 502 of the UE 501 at 512. At 534, the RLC layer 503 of the UE 501 may generate the last RLC PDU based on the PDCP PDU received from the PDCP layer 502 of the UE 501 at 512.

The MAC layer 504 of the UE 501 may transmit at least one MAC PDU to the MAC layer 506 of the base station 505. That is, the MAC layer 504 of the UE 501 may generate the at least one MAC PDU based on the at least one RLC PDU received from the RLC layer 503 of the UE 501. In one aspect, the MAC PDU 504 of the UE 501 may be transmitted to the base station 505 through a lower layer, e.g., a physical layer, using transport channels of the lower layer. At 515, 516, 526, 535, and 536, the MAC layer 504 of the UE 501 may transmit or retransmit at least one MAC PDU to the MAC layer 506 of the base station 505. At 515 and 516, the MAC layer 504 of the UE 501 may transmit or retransmit the first MAC PDU to the MAC layer 506 of the base station 505. At 535 or 536, the MAC layer 504 of the UE 501 may transmit or retransmit the last MAC PDU to the MAC layer 506 of the base station 505.

The MAC layer 506 of the base station 505 may decode the at least one MAC PDU received from the MAC layer 504 of the UE 501. In some aspects, the MAC layer 506 of the base station 505 may fail to decode a MAC PDU received from the MAC layer 504 of the UE 501, and the MAC layer 504 of the UE 501 may perform a retransmission of the MAC PDU that the MAC layer 506 of the base station 505 failed to decode. In one aspect, the MAC layer 506 of the base station 505 may transmit a feedback to the MAC layer 504 of the UE 501 to indicate that the MAC PDU was not successfully transmitted and request a retransmission of the MAC PDU. At 516 and 536, the MAC layer 504 of the UE 501 may retransmit the MAC PDUs transmitted at 515 and 535. In one example, the MAC layer 506 of the base station 505 may fail to decode the first MAC PDU received at 515 and the MAC layer 504 of the UE 501 may retransmit the first MAC PDU at 516. In another example, the MAC layer 506 of the base station 505 may fail to decode the last MAC PDU received at 535 and the MAC layer 504 of the UE 501 may retransmit the last MAC PDU at 536.

The MAC layer 506 of the base station 505 may transmit at least one RLC PDU to the RLC layer 507 of the base station 505. That is, the MAC layer 506 of the base station 505 may decode the at least one MAC PDU received from the MAC layer 504 of the UE 501 to generate the corresponding at least one RLC PDU, and transmit the at least one RLC PDU to the RLC layer 507 of the base station 505. At 518, 528, and 538, MAC layer 506 of the base station 505 may generate the at least one MAC PDU received at 516, 526, and 536, and transmit the RLC PDU to the RLC layer 507 of the base station 505.

The RLC layer 507 of the base station 505 may transmit the PDCP PDU to the PDCP layer 508 of the base station 505. That is, the RLC layer may generate the PDCP PDU based on the at least one RLC PDU received from the MAC layer 506 of the base station 505, and transmit the PDCP PDU to the PDCP layer 508 of the base station 505. After receiving the last RLC PDU from the MAC layer 506 of the base station 505 at 538, the RLC layer 507 of the base station 505 may generate the PDCP PDU based on the at least one RLC PDU at 518, 528, and 538, and transmit the PDCP PDU to the PDCP layer at 539.

Based on the PDCP PDU received at 539, the PDCP layer 508 of the base station 505 may identify the timing information associated with the SDU that arrived at the PDCP layer 502 of the UE 501. That is, the base station 505 may identify the arrival time associated with the arrival of the SDU at the PDCP layer 502 of the UE 501 from the PDCP PDU received at 539. Here, the timing information may include the arrival time (SFN_s, SN_s) that the SDU arrives in the PDCP queue, and the timing information may be included in the header of the PDCU PDU transmitted received at 539. Accordingly, the base station 505 may identify the arrival time (SFN_s, SN_s) indicating the system time that the SDU arrived in the PDCP queue, as reported in the header of the PDCP PDU by the UE 501.

The base station 505 may calculate an UL delay 540 based on at least on the timing information from the UE 501. Here, upon delivery of the PDCP PDU from the RLC layer 507 of the base station 505, the base station 505 may calculate the UL delay 540 on the air interface of the corresponding SDU based on at least the timing information reported by the UE, the timing information including the arrival time associated with the arrival of the SDU at the PDCP layer 502 of the UE 501.

The base station 505 may calculate the UL delay 540 based on the arrival time associated with the arrival of the SDU at the PDCP layer 502 of the UE 501 and a receive time associated with successfully receiving, from the UE 501, the last MAC PDU associated with the UL data at 536. That is, the base station may identify the receive time associated with successfully receiving the last MAC PDU associated with the UL data from the UE 501 at 536. In one example, the receive time (SFN_rx, SN_rx) may indicate the receive time that the last MAC PDU associated with the UL data was successfully received at the MAC layer 506 of the base station 505, where SFN_rx is a system frame number and SN_rx is a slot number of the system time that the last MAC PDU associated with the UL data was successfully received at the MAC layer 506 of the base station 505 from the MAC layer 504 of the UE 501. That is, the base station 505 may calculate the UL delay 540 as (SFN_rx,SN_rx)−(SFN_s,SN_s), where (SFN_s,SN_s) is the arrival time indicating the system time as reported by the UE in the PDCP PDU, and (SFN_rx,SN_rx) is the receive time indicating the system time of the successful reception of the last MAC PDU that carries data from the SDU.

In some aspects, the PDCP PDU may have a particular structure to carry the timing information. That is, the PDCP PDU may have a header configured to include the timing information. Here, the timing information may include the arrival time (SFN_s, SN_s), indicating the system time that the SDU arrived in the PDCP queue, and the PDCP PDU header may be configured to carry the arrival time (SFN_s, SN_s). The UE 501 may include the arrival time (SFN_s, SN_s) in the PDCP PDU header, and the base station 505 may identify the arrival time (SFN_s, SN_s) as the UE 501 reported in the PDCP PDU header.

In one aspect, the PDCP PDU header may be built before the actual start of the transmission on the air interface. That is, the UE 501 may build the PDCP PDU header including the timing information indicating the arrival time associated with the arrival of the SDU at the PDCP layer 502 of the UE 501 before transmitting the UL data on the air interface. In another aspect, the base station may calculate the UL delay 540 without determining when the first HARQ transmission of the first MAC PDU was transmitted. That is, the base station may calculate the UL delay 540 based on the arrival time reported by the UE 501 in the PDCP PDU header and the receive time associated with successfully receiving the last MAC PDU at 536, without identifying the time that the transmission of the first MAC PDU was first attempted at 515.

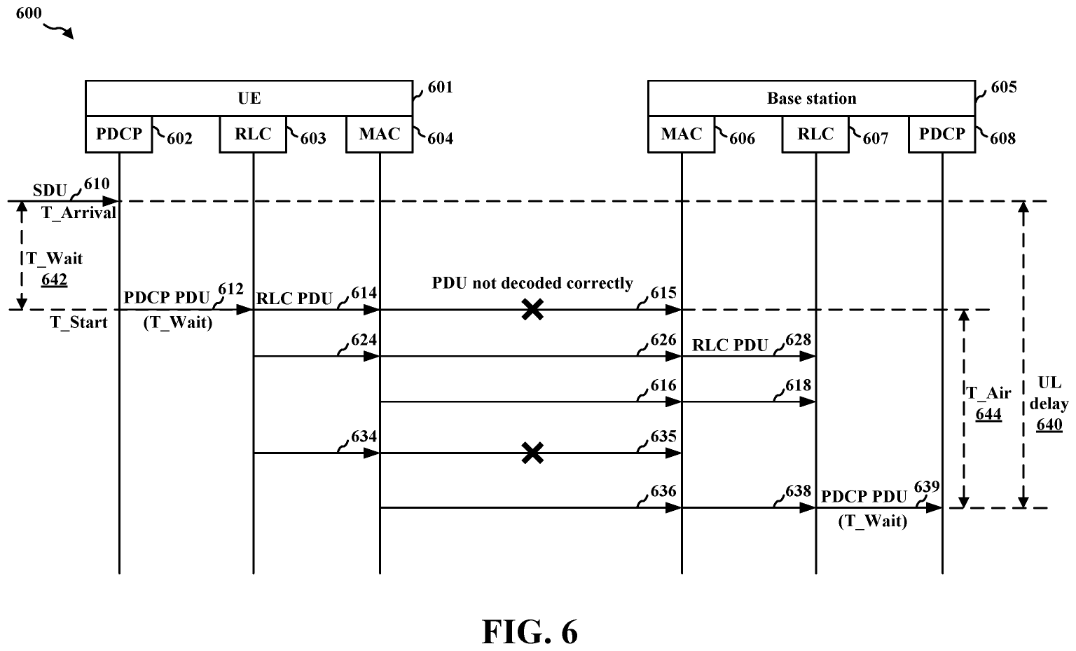

FIG. 6 is a call-flow chart of a method of wireless communication. The call-flow diagram 600 may include a UE 601 including a PDCP layer 602, an RLC layer 603, and a MAC layer, and a base station 605 including a MAC layer 606, an RLC layer 607, and a PDCP layer 608. In some aspects, the timing information may include a first wait time T_Wait 642 associated with a first time difference between an arrival time T_Arrival associated with the arrival of the SDU at the PDCP layer 602 of the UE 601 and a transmission time T_Start associated with transmitting, to the base station 605, the first MAC PDU containing UL data of the SDU at 615.

At 610, the UE 601 may receive the SDU from a higher layer, e.g., the application layer, including UL data to be transmitted to the base station 605. Here, the first wait time 642 may be the first time difference T_Wait 642 between the arrival time T_Arrival indicating the system time that the SDU arrived at the PDCP layer 602 of the UE 601 and the transmission time T_Start indicating the system time that the first MAC PDU containing UL data of the SDU is transmit to the base station 605 at 615. That is, the UE 601 may calculate the first wait time 642 between the arrival time T_Arrival indicating the system time that the SDU arrived at the PDCP layer 602 of the UE 601 and the transmission time T_Start indicating the system time that the first MAC PDU containing UL data of the SDU is transmit to the base station 605 at 615, and report the first wait time 642 to the base station 605 in the PDCP PDU.

At 612, a PDCP PDU may be transmitted from the PDCP layer 602 of the UE 601 to the RLC layer 603 of the UE 601. That is, the PDCP layer 602 of the UE 601 may generate the PDCP PDU based on the SDU received at 610 from the higher layer, and transmit the PDCP PDU to the RLC layer 603 of the UE 601.

Here, the PDCP layer 602 of the UE 601 may include, in the PDCP PDU transmitted at 612, the timing information including the first wait time 642 between the arrival time T_Arrival indicating the system time that the SDU arrived at the PDCP layer 602 of the UE 601 and the transmission time T_Start indicating the system time that the first MAC PDU containing UL data of the SDU is transmit to the base station 605 at 615. That is, the PDCP layer 602 of the UE 601 may include the first wait time 642 as the timing information in the PDCP PDU transmitted to the 612. The timing information may include the first wait time 642 between the arrival time T_Arrival indicating the system time that the SDU arrived at the PDCP queue and the transmission time T_Start indicating the system time that the first MAC PDU containing UL data of the SDU is transmit to the base station 605, and the PDCP layer 602 of the UE 601 may include the timing information in the PDCU PDU transmitted at 612. In one aspect, the PDCP layer 602 of the UE 601 may include the timing information in a header of the PDCP PDU transmitted at the 612. In one example, the header of the PDCP PDU transmitted at 612 may have a particular structure to carry the timing information.

The RLC layer 603 of the UE 601 may transmit at least one RLC PDU to the MAC layer 604 of the UE 601 based on the PDCP PDU received from the PDCP layer 602 of the UE 601. That is, the RLC layer 603 of the UE 601 may generate the at least one RLC PDU based on the PDCP PDU received from the PDCP layer 602 of the UE 601, and transmit the RLC PDU to the MAC layer 604 of the UE 601 for the MAC layer 604 of the UE 601. At 614, 624, and 634, the RLC layer 603 of the UE 601 may transmit at least one RLC PDU to the MAC layer 604 of the UE 601. At 614, the RLC layer 603 of the UE 601 may generate the first RLC PDU based on the PDCP PDU received from the PDCP layer 602 of the UE 601 at 612. At 634, the RLC layer 603 of the UE 601 may generate the last RLC PDU based on the PDCP PDU received from the PDCP layer 602 of the UE 601 at 612.

The MAC layer 604 of the UE 601 may transmit at least one MAC PDU to the MAC layer 606 of the base station 605. That is, the MAC layer 604 of the UE 601 may generate the at least one MAC PDU based on the at least one RLC PDU received from the RLC layer 603 of the UE 601. In one aspect, the MAC PDU 604 of the UE 601 may be transmitted to the base station 605 through a lower layer, e.g., a physical layer, using transport channels of the lower layer. At 615, 616, 626, 635, and 636, the MAC layer 604 of the UE 601 may transmit or retransmit at least one MAC PDU to the MAC layer 606 of the base station 605. At 615 and 616, the MAC layer 604 of the UE 601 may transmit or retransmit the first MAC PDU to the MAC layer 606 of the base station 605. At 635 or 636, the MAC layer 604 of the UE 601 may transmit or retransmit the last MAC PDU to the MAC layer 606 of the base station 605.

The MAC layer 606 of the base station 605 may decode the at least one MAC PDU received from the MAC layer 604 of the UE 601. In some aspects, the MAC layer 606 of the base station 605 may fail to decode a MAC PDU received from the MAC layer 604 of the UE 601, and the MAC layer 604 of the UE 601 may perform a retransmission of the MAC PDU that the MAC layer 606 of the base station 605 failed to decode. In one aspect, the MAC layer 606 of the base station 605 may transmit a feedback to the MAC layer 604 of the UE 601 to indicate that the MAC PDU was not successfully transmitted and request a retransmission of the MAC PDU. At 616 and 636, the MAC layer 604 of the UE 601 may retransmit the MAC PDUs transmitted at 615 and 635. In one example, the MAC layer 606 of the base station 605 may fail to decode the first MAC PDU received at 615 and the MAC layer 604 of the UE 601 may retransmit the first MAC PDU at 616. In another example, the MAC layer 606 of the base station 605 may fail to decode the last MAC PDU received at 635 and the MAC layer 604 of the UE 601 may retransmit the last MAC PDU at 636.

The MAC layer 606 of the base station 605 may transmit at least one RLC PDU to the RLC layer 607 of the base station 605. That is, the MAC layer 606 of the base station 605 may decode the at least one MAC PDU received from the MAC layer 604 of the UE 601 to generate the corresponding at least one RLC PDU, and transmit the at least one RLC PDU to the RLC layer 607 of the base station 605. At 618, 628, and 638, MAC layer 606 of the base station 605 may generate the at least one MAC PDU received at 616, 626, and 636, and transmit the RLC PDU to the RLC layer 607 of the base station 605.

The RLC layer 607 of the base station 605 may transmit the PDCP PDU to the PDCP layer 608 of the base station 605. That is, the RLC layer may generate the PDCP PDU based on the at least one RLC PDU received from the MAC layer 606 of the base station 605, and transmit the PDCP PDU to the PDCP layer 608 of the base station 605. After receiving the last RLC PDU from the MAC layer 606 of the base station 605 at 638, the RLC layer 607 of the base station 605 may generate the PDCP PDU based on the at least one RLC PDU at 618, 628, and 638, and transmit the PDCP PDU to the PDCP layer at 639.

The base station 605 may calculate the UL delay 640 based on at least on the timing information from the UE 601. Here, upon delivery of the PDCP PDU from the RLC layer 607 of the base station 605, the base station 605 may calculate the UL delay 640 on the air interface of the corresponding SDU based on at least the timing information reported by the UE, the timing information including the first wait time 642, the transmission time T_Start associated with transmitting, to the base station 605, the first MAC PDU containing UL data of the SDU at 615, and a receive time associated with successfully receiving the last MAC PDU associated with the UL data from the UE 601 at 636.

In some aspects, the base station may calculate the UL delay 640 by adding the first wait time 642 indicating the first time difference T_Wait 642 between the arrival time T_Arrival indicating the system time that the SDU arrived at the PDCP layer 602 of the UE 601 and the transmission time T_Start indicating the system time that the first MAC PDU containing UL data of the SDU is transmit to the base station 605 at 615, and a second time difference T_Air 644 between a transmission of the first MAC PDU containing UL data of the SDU at 615 and the receive time associated with successfully receiving the last MAC PDU associated with the UL data from the UE 601 at 636. That is, the base station may calculate the UL delay 640 as T_Wait+T_Air. T_Wait may refer to the first time difference 642 between the arrival time T_Arrival associated with the arrival of the SDU at the PDCP layer 602 of the UE 601 and the transmission time T_Start associated with transmitting, to the base station 605, the first MAC PDU containing UL data of the SDU at 615. T_Air may refer to the second time difference 644 between the first transmission of the first MAC PDU containing the UL data of the SDU at 615 and the receive time associated with successfully receiving the last MAC PDU associated with the UL data from the UE 601 at 636.

Here, the first time difference 642 may be reported by the UE 601 in the PDCP PDU. In some aspects, the PDCP PDU may have a particular structure to carry the timing information. That is, the PDCP PDU may have a header configured to include the timing information. Here, the timing information may include the first wait time T_Wait 642 associated with a first time difference between an arrival time T_Arrival associated with the arrival of the SDU at the PDCP layer 602 of the UE 601 and a transmission time T_Start associated with transmitting, to the base station 605, the first MAC PDU containing UL data of the SDU at 615. The UE 601 may include the first wait time T_Wait 642 in the PDCP PDU header, and the base station 605 may identify the first wait time T_Wait 642 as the UE 601 reported in the PDCP PDU header.

The base station 605 may calculate the second time difference T_Air 644 between the first transmission of the first MAC PDU containing UL data of the SDU at 615 and the receive time associated with successfully receiving the last MAC PDU associated with the UL data from the UE 601 at 636. In one aspect, the base station 605 may identify the transmission time T_Start associated with transmitting, to the base station 605, the first MAC PDU containing the UL data of the SDU at 615. That is, the base station 605 may identify the transmission time T_Start indicating the system time corresponding to first attempt to receive, from the UE 601, the first MAC PDU containing UL data of the SDU at 615. In another aspect, the base station 605 may identify the successful reception of the last MAC PDU associated with the UL data from the UE 601 at 636. That is, the base station 605 may identify the receive time indicating the system time corresponding to successfully receiving, from the UE 601, the last MAC PDU containing the UL data of the SDU at 636.

In some aspects, the PDCP PDU may have a particular structure to carry the timing information. That is, the PDCP PDU may have a header configured to include the timing information. Here, the timing information may include the first wait time T_Wait 642 indicating the first time difference between an arrival time T_Arrival associated with the arrival of the SDU at the PDCP layer 602 of the UE 601 and a transmission time T_Start associated with transmitting, to the base station 605, the first MAC PDU containing UL data of the SDU at 615, and the PDCP PDU header may be configured to carry the first wait time T_Wait 642. The UE 601 may include the first wait time T_Wait 642 in the PDCP PDU header, and the base station 605 may identify the first wait time T_Wait 642 as the UE 601 reported in the PDCP PDU header.

In one aspect, the UE 601 may be configured to know or receive the instruction of the transmission opportunity of the first MAC PDU to calculate or generate the first wait time T_Wait 642, and the UE 601 may receive, from the base station 605, the UL DCI including the instruction of the first transmission opportunity of the first MAC PDU. Accordingly, the UE 601 may generate the first wait time T_Wait 642 after receiving, from the base station 605, the UL DCI including the instruction of the first transmission opportunity of the first MAC PDU, and the UE 601 may build the PDCP PDU header after calculating the first wait time T_Wait 642 after receiving the UL DCI to include the first wait time T_Wait 642 in the PDCP PDU header.

In another aspect, determining the second time difference T_Air 644 may be complicated for the base station 605, since the first transmission of the first MAC PDU may be subject to several HARQ retransmissions. That is, when the MAC layer 606 of the base station 605 may fail to decode a MAC PDU received from the MAC layer 604 of the UE 601, the MAC layer 604 of the UE 601 may perform multiple HARQ retransmission of the MAC PDU, and the base station 605 may not accurately identify the transmission time T_Start associated with the UE 601 transmitting the first MAC PDU containing UL data of the SDU to the base station 605 for the first time.

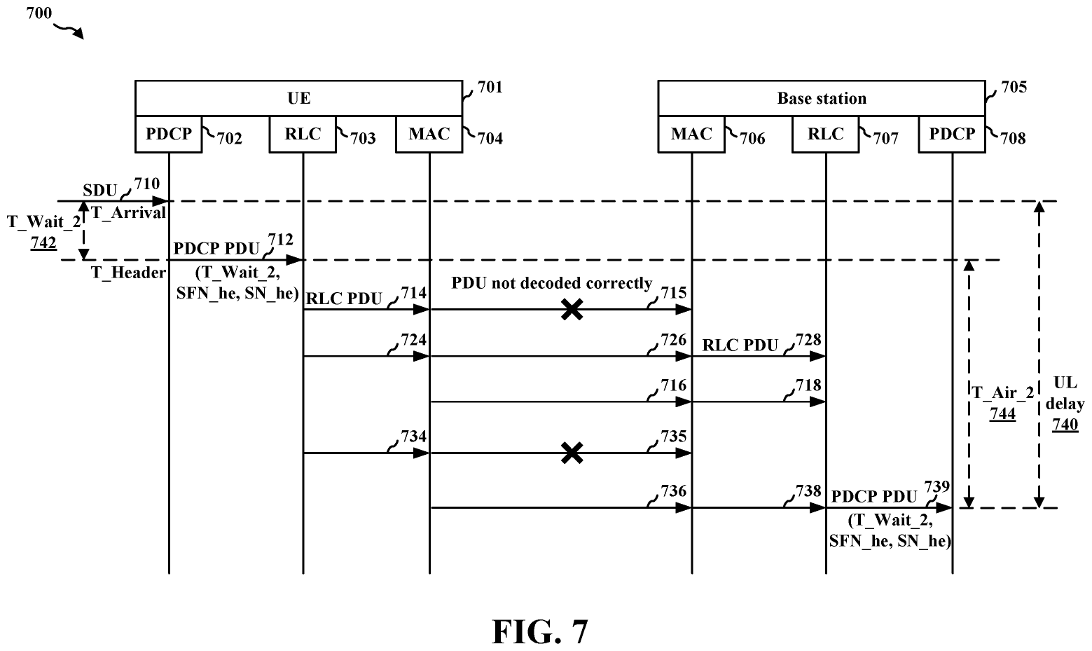

FIG. 7 is a call-flow chart of a method of wireless communication. The call-flow diagram 700 may include a UE 701 including a PDCP layer 702, an RLC layer 703, and a MAC layer, and a base station 705 including a MAC layer 706, an RLC layer 707, and a PDCP layer 708. In some aspects, the timing information may include a second wait time T_Wait_2 742 associated with a third time difference between an arrival time T_Arrival associated with the arrival of the SDU at the PDCP layer 702 of the UE 701 and a header time T_Header associated with building a header of the PDCP PDU.

At 710, the UE 701 may receive the SDU from a higher layer, e.g., the application layer, including UL data to be transmitted to the base station 705. Here, the second wait time T_Wait_2 742 may be the third time difference between the arrival time T_Arrival indicating the system time that the SDU arrived at the PDCP layer 702 of the UE 701 and the header time T_Header indicating the system time that the PDCP layer 702 of the UE 701 builds the PDCP PDU header based on the SDU. That is, the UE 701 may calculate the second wait time T_Wait_2 742 between the arrival time T_Arrival indicating the system time that the SDU arrived at the PDCP layer 702 of the UE 701 and the header time T_Header indicating the system time that the PDCP layer 702 of the UE 701 builds the PDCP PDU header based on the SDU, and report the second wait time 742 to the base station 705 and the header time T_Header in the PDCP PDU.

At 712, a PDCP PDU may be transmitted from the PDCP layer 702 of the UE 701 to the RLC layer 703 of the UE 701. That is, the PDCP layer 702 of the UE 701 may generate the PDCP PDU based on the SDU received at 710 from the higher layer, and transmit the PDCP PDU to the RLC layer 703 of the UE 701.

Here, the PDCP layer 702 of the UE 701 may include, in the PDCP PDU transmitted at 712, the timing information including the second wait time T_Wait_2 742 between the arrival time T_Arrival indicating the system time that the SDU arrived at the PDCP layer 702 of the UE 701 and the header time T_Header indicating the system time that the PDCP layer 702 of the UE 701 builds the PDCP PDU header based on the SDU. That is, the PDCP layer 702 of the UE 701 may include the second wait time 742 and the header time T_Header as the timing information in the PDCP PDU transmitted to the 712. The timing information may include the second wait time 742 between the arrival time T_Arrival indicating the system time that the SDU arrived at the PDCP queue and the header time T_Header indicating the system time that the UE 701 builds the PDCP PDU header, and the PDCP layer 702 of the UE 701 may include the timing information in the PDCU PDU transmitted at 712. In one aspect, the PDCP layer 702 of the UE 701 may include the timing information in the header of the PDCP PDU transmitted at the 712. In one example, the header of the PDCP PDU transmitted at 712 may have a particular structure to carry the timing information.

The RLC layer 703 of the UE 701 may transmit at least one RLC PDU to the MAC layer 704 of the UE 701 based on the PDCP PDU received from the PDCP layer 702 of the UE 701. That is, the RLC layer 703 of the UE 701 may generate the at least one RLC PDU based on the PDCP PDU received from the PDCP layer 702 of the UE 701, and transmit the RLC PDU to the MAC layer 704 of the UE 701 for the MAC layer 704 of the UE 701. At 714, 724, and 734, the RLC layer 703 of the UE 701 may transmit at least one RLC PDU to the MAC layer 704 of the UE 701. At 714, the RLC layer 703 of the UE 701 may generate the first RLC PDU based on the PDCP PDU received from the PDCP layer 702 of the UE 701 at 712. At 734, the RLC layer 703 of the UE 701 may generate the last RLC PDU based on the PDCP PDU received from the PDCP layer 702 of the UE 701 at 712.

The MAC layer 704 of the UE 701 may transmit at least one MAC PDU to the MAC layer 706 of the base station 705. That is, the MAC layer 704 of the UE 701 may generate the at least one MAC PDU based on the at least one RLC PDU received from the RLC layer 703 of the UE 701. In one aspect, the MAC PDU 704 of the UE 701 may be transmitted to the base station 705 through a lower layer, e.g., a physical layer, using transport channels of the lower layer. At 715, 716, 726, 735, 736, the MAC layer 704 of the UE 701 may transmit and retransmit at least one MAC PDU to the MAC layer 706 of the base station 705. At 715 and 716, the MAC layer 704 of the UE 701 may transmit and retransmit the first MAC PDU to the MAC layer 706 of the base station 705. At 735 and 736, the MAC layer 704 of the UE 701 may transmit and retransmit the last MAC PDU to the MAC layer 706 of the base station 705.

The MAC layer 706 of the base station 705 may decode the at least one MAC PDU received from the MAC layer 704 of the UE 701. In some aspects, the MAC layer 706 of the base station 705 may fail to decode a MAC PDU received from the MAC layer 704 of the UE 701, and the MAC layer 704 of the UE 701 may perform a retransmission of the MAC PDU that the MAC layer 706 of the base station 705 failed to decode. In one aspect, the MAC layer 706 of the base station 705 may transmit a feedback to the MAC layer 704 of the UE 701 to indicate that the MAC PDU was not successfully transmitted and request a retransmission of the MAC PDU. At 716 and 736, the MAC layer 704 of the UE 701 may retransmit the MAC PDUs transmitted at 715 and 735. In one example, the MAC layer 706 of the base station 705 may fail to decode the first MAC PDU received at 715 and the MAC layer 704 of the UE 701 may retransmit the first MAC PDU at 716. In another example, the MAC layer 706 of the base station 705 may fail to decode the last MAC PDU received at 735 and the MAC layer 704 of the UE 701 may retransmit the last MAC PDU at 736.

The MAC layer 706 of the base station 705 may transmit at least one RLC PDU to the RLC layer 707 of the base station 705. That is, the MAC layer 706 of the base station 705 may decode the at least one MAC PDU received from the MAC layer 704 of the UE 701 to generate the corresponding at least one RLC PDU, and transmit the at least one RLC PDU to the RLC layer 707 of the base station 705. At 718, 728, and 738, MAC layer 706 of the base station 705 may generate the at least one MAC PDU received at 716, 726, and 736, and transmit the RLC PDU to the RLC layer 707 of the base station 705.

The RLC layer 707 of the base station 705 may transmit the PDCP PDU to the PDCP layer 708 of the base station 705. That is, the RLC layer may generate the PDCP PDU based on the at least one RLC PDU received from the MAC layer 706 of the base station 705, and transmit the PDCP PDU to the PDCP layer 708 of the base station 705. After receiving the last RLC PDU from the MAC layer 706 of the base station 705 at 738, the RLC layer 707 of the base station 705 may generate the PDCP PDU based on the at least one RLC PDU at 718, 728, and 738, and transmit the PDCP PDU to the PDCP layer at 739.

The base station 705 may calculate the UL delay 740 based on at least on the timing information from the UE 701. Here, upon delivery of the PDCP PDU from the RLC layer 707 of the base station 705, the base station 705 may calculate the UL delay 740 on the air interface of the corresponding SDU based on at least the timing information reported by the UE, the timing information including the second wait time 742, the header time T_Header associated with building the PDCP PDU header, and a receive time associated with successfully receiving the last MAC PDU associated with the UL data from the UE 701 at 736.

In some aspects, the base station may calculate the UL delay 740 by adding the second wait time 742 indicating the second wait time T_Wait_2 742 between the arrival time T_Arrival indicating the system time that the SDU arrived at the PDCP layer 702 of the UE 701 and the header time T_Header indicating the system time associated with building the PDCP PDU header, and a fourth time difference T_Air_2 744 between the header time T_Header indicating the system time associated with building the PDCP PDU header and the receive time associated with successfully receiving the last MAC PDU associated with the UL data from the UE 701 at 736. That is, the base station may calculate the UL delay 740 as T_Wait_2+T_Air_2. T_Wait_2 may refer to the third time difference 742 between the arrival time T_Arrival associated with the arrival of the SDU at the PDCP layer 702 of the UE 701 and the header time T_Header indicating the system time associated with building the PDCP PDU header. T_Air_2 may refer to the fourth time difference 744 between the header time T_Header indicating the system time associated with building the PDCP PDU header and the receive time associated with successfully receiving the last MAC PDU associated with the UL data from the UE 701 at 736.

The header time T_Header may indicate the system time associated with building the PDCP PDU header at the PDCP layer 502 of the UE 501. In one example, the header time T_Header (SFN_he, SN_he) may indicate the system time that the PDCP layer 702 of the UE 701 builds the PDCP PDU header, where SFN_he is a system frame number and SN_he is a slot number of the system time that the PDCP layer 702 of the UE 701 builds the PDCP PDU header.

The third time difference 742 and the header time T_Header may be reported by the UE 701 in the PDCP PDU. In some aspects, the PDCP PDU may have a particular structure to carry the timing information. That is, the PDCP PDU may have a header configured to include the timing information. Here, the timing information may include the header time T_Header (SFN_he, SN_he) associated with the building of the PDCP PDU header and the second wait time T_Wait_2 742 associated with the third time difference between an arrival time T_Arrival associated with the arrival of the SDU at the PDCP layer 702 of the UE 701 and the header time T_Header. The UE 501 may include the second wait time T_Wait_2 742 and the header time T_Header (SFN_he, SN_he) in the PDCP PDU header, and the base station 505 may identify the second wait time T_Wait_2 742 and the header time T_Header (SFN_he, SN_he) as the UE 701 reported in the PDCP PDU header.

The base station 705 may calculate the fourth time difference T_Air_2 744 between the header time T_Header (SFN_he, SN_he) associated with the building of the PDCP PDU header and the receive time associated with successfully receiving the last MAC PDU associated with the UL data from the UE 701 at 736. In one aspect, the base station 705 may identify the header time T_Header (SFN_he, SN_he) associated with the building of the PDCP PDU header as reported by the UE 701. That is, the header time T_Header (SFN_he, SN_he) indicating the system time that the PDCP layer 702 of the UE 701 built the PDCP PDU header may be reported from the UE 701 in the PDCP PDU header, and the base station 705 may identify the header time T_Header (SFN_he, SN_he) from the PDCP PDU header. In another aspect, the base station 705 may identify the successful reception of the last MAC PDU associated with the UL data from the UE 701 at 736. That is, the base station 705 may identify the receive time indicating the system time corresponding to successfully receiving, from the UE 501, the last MAC PDU containing the UL data of the SDU at 736. In one example, the receive time (SFN_rx, SN_rx) may indicate the receive time that the last MAC PDU associated with the UL data was successfully received at the MAC layer 706 of the base station 705, where SFN_rx is a system frame number and SN_rx is a slot number of the system time that the last MAC PDU associated with the UL data was successfully received at the MAC layer 706 of the base station 705 from the MAC layer 704 of the UE 701. That is, the base station 705 may calculate the fourth time difference T_Air_2 744 as (SFN_rx, SN_rx)−(SFN_he, SN_he), where (SFN_rx, SN_rx) is the receive time indicating the system time of the successful reception of the last MAC PDU that carries data from the SDU. Accordingly, the UL delay may be calculated as T_Wait_2+(SFN_rx, SN_rx)−(SFN_he, SN_he), where T_Wait_2 742 and (SFN_he, SN_he) are reported by the UE 701 in the PDCP PDU header.

In some aspects, the PDCP PDU may have a particular structure to carry the timing information. That is, the PDCP PDU may have a header configured to include the timing information. Here, the timing information may include the header time T_Header (SFN_he, SN_he) associated with the building of the PDCP PDU header and the second wait time T_Wait_2 742 indicating the third time difference between the arrival time T_Arrival associated with the arrival of the SDU at the PDCP layer 702 of the UE 701 and the header time T_Header (SFN_he, SN_he) associated with the building of the PDCP PDU header, and the PDCP PDU header may be configured to carry the second wait time T_Wait_2 742 and the header time T_Header (SFN_he, SN_he). The UE 501 may include the second wait time T_Wait_2 742 and the header time T_Header (SFN_he, SN_he) in the PDCP PDU header, and the base station 505 may identify the second wait time T_Wait_2 742 and the header time T_Header (SFN_he, SN_he) as the UE 501 reported in the PDCP PDU header.

Compared to the call-flow diagram 600 of FIG. 6, the PDCP layer 702 of the UE 701 may build the PDCP header before initiating the transmission of the first MAC PDU on the air interface. That is, the UE 701 may be configured to report the header time T_Header (SFN_he, SN_he), and therefore, the UE 701 may include the header time T_Header (SFN_he, SN_he) to build the PDCP PDU header before receiving any instruction for the first transmission opportunity of the first MAC PDU to the base station 705. Also, the base station 705 may not detect when the 1st HARQ transmission of the 1st MAC PDU took place, which may be complicate for the base station 705 to detect. That is, the base station 705 may be configured to determining the fourth time difference T_Air_2 744 based on the receive time associated with successfully receiving the last MAC PDU associated with the UL data from the UE 701 at 736 and the second wait time T_Wait_2 742 and the header time T_Header (SFN_he, SN_he) reported from the UE 701.

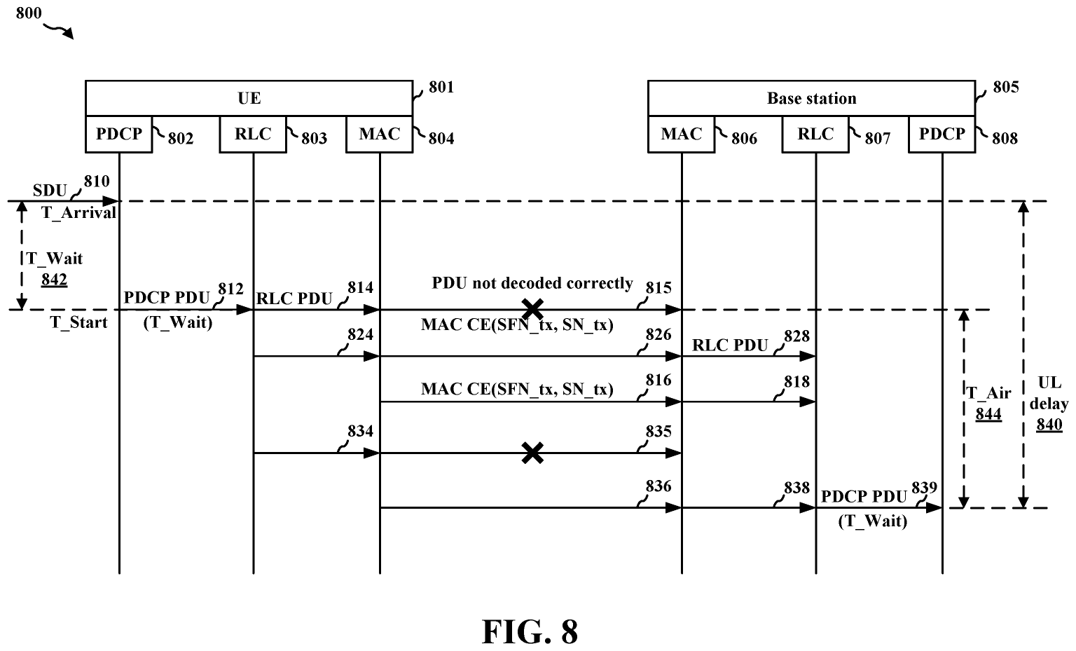

FIG. 8 is a call-flow chart of a method of wireless communication. The call-flow diagram 800 may include a UE 801 including a PDCP layer 802, an RLC layer 803, and a MAC layer, and a base station 805 including a MAC layer 806, an RLC layer 807, and a PDCP layer 808. In some aspects, the timing information may include a first wait time T_Wait 842 associated with a first time difference between an arrival time T_Arrival associated with the arrival of the SDU at the PDCP layer 802 of the UE 801 and a transmission time T_Start associated with transmitting, to the base station 805, the first MAC PDU containing UL data of the SDU at 815.

At 810, the UE 801 may receive the SDU from a higher layer, e.g., the application layer, including UL data to be transmitted to the base station 805. Here, the first wait time 842 may be the first time difference T_Wait 842 between the arrival time T_Arrival indicating the system time that the SDU arrived at the PDCP layer 802 of the UE 801 and the transmission time T_Start indicating the system time that the first MAC PDU containing UL data of the SDU is transmit to the base station 805 at 815. That is, the UE 801 may calculate the first wait time 842 between the arrival time T_Arrival indicating the system time that the SDU arrived at the PDCP layer 802 of the UE 801 and the transmission time T_Start indicating the system time that the first MAC PDU containing UL data of the SDU is transmit to the base station 805 at 815, and report the first wait time 842 to the base station 805 in the PDCP PDU.

At 812, a PDCP PDU may be transmitted from the PDCP layer 802 of the UE 801 to the RLC layer 803 of the UE 801. That is, the PDCP layer 802 of the UE 801 may generate the PDCP PDU based on the SDU received at 810 from the higher layer, and transmit the PDCP PDU to the RLC layer 803 of the UE 801.

Here, the PDCP layer 802 of the UE 801 may include, in the PDCP PDU transmitted at 812, the timing information including the first wait time 842 between the arrival time T_Arrival indicating the system time that the SDU arrived at the PDCP layer 802 of the UE 801 and the transmission time T_Start indicating the system time that the first MAC PDU containing UL data of the SDU is transmit to the base station 805 at 815. That is, the PDCP layer 802 of the UE 801 may include the first wait time 842 as the timing information in the PDCP PDU transmitted to the 812. The timing information may include the first wait time 842 between the arrival time T_Arrival indicating the system time that the SDU arrived at the PDCP queue and the transmission time T_Start indicating the system time that the first MAC PDU containing UL data of the SDU is transmit to the base station 805, and the PDCP layer 802 of the UE 801 may include the timing information in the PDCU PDU transmitted at 812. In one aspect, the PDCP layer 802 of the UE 801 may include the timing information in a header of the PDCP PDU transmitted at the 812. In one example, the header of the PDCP PDU transmitted at 812 may have a particular structure to carry the timing information.

The RLC layer 803 of the UE 801 may transmit at least one RLC PDU to the MAC layer 804 of the UE 801 based on the PDCP PDU received from the PDCP layer 802 of the UE 801. That is, the RLC layer 803 of the UE 801 may generate the at least one RLC PDU based on the PDCP PDU received from the PDCP layer 802 of the UE 801, and transmit the RLC PDU to the MAC layer 804 of the UE 801 for the MAC layer 804 of the UE 801. At 814, 824, and 834, the RLC layer 803 of the UE 801 may transmit at least one RLC PDU to the MAC layer 804 of the UE 801. At 814, the RLC layer 803 of the UE 801 may generate the first RLC PDU based on the PDCP PDU received from the PDCP layer 802 of the UE 801 at 812. At 834, the RLC layer 803 of the UE 801 may generate the last RLC PDU based on the PDCP PDU received from the PDCP layer 802 of the UE 801 at 812.

The MAC layer 804 of the UE 801 may transmit at least one MAC PDU to the MAC layer 806 of the base station 805. That is, the MAC layer 804 of the UE 801 may generate the at least one MAC PDU based on the at least one RLC PDU received from the RLC layer 803 of the UE 801. In one aspect, the MAC PDU 804 of the UE 801 may be transmitted to the base station 805 through a lower layer, e.g., a physical layer, using transport channels of the lower layer. At 815, 816, 826, 835, and 836, the MAC layer 804 of the UE 801 may transmit or retransmit at least one MAC PDU to the MAC layer 806 of the base station 805. At 815 and 816, the MAC layer 804 of the UE 801 may transmit or retransmit the first MAC PDU to the MAC layer 806 of the base station 805. At 835 and 836, the MAC layer 804 of the UE 801 may transmit or retransmit the last MAC PDU to the MAC layer 806 of the base station 805.

Here, the MAC layer 804 of the UE 801 may include the transmission time T_Start indicating the system time that the first MAC PDU containing UL data of the SDU is transmit to the base station 805. That is, the first MAC PDU transmitted at 815 and retransmitted at 816 may carry the MAC-CE including the transmission time T_Start. In one example, the first MAC PDU transmitted at 815 and retransmitted at 816 may carry the MAC-CE including the transmission time T_Start (SFN_tx, SN_tx), where SFN_tx is a system frame number and SN_tx is a slot number of the system time that the first MAC PDU containing UL data of the SDU is transmit to the base station 805. In one aspect, the MAC-CE including the transmission time T_Start (SFN_tx, SN_tx) may include a dedicated field to carry the transmission time T_Start (SFN_tx, SN_tx). In another aspect, the transmission time T_Start (SFN_tx, SN_tx) may be reported in a buffer status report (BSR).

The MAC layer 806 of the base station 805 may decode the at least one MAC PDU received from the MAC layer 804 of the UE 801. In some aspects, the MAC layer 806 of the base station 805 may fail to decode a MAC PDU received from the MAC layer 804 of the UE 801, and the MAC layer 804 of the UE 801 may perform a retransmission of the MAC PDU that the MAC layer 806 of the base station 805 failed to decode. In one aspect, the MAC layer 806 of the base station 805 may transmit a feedback to the MAC layer 804 of the UE 801 to indicate that the MAC PDU was not successfully transmitted and request a retransmission of the MAC PDU. At 816 and 836, the MAC layer 804 of the UE 801 may retransmit the MAC PDUs transmitted at 815 and 835. In one example, the MAC layer 806 of the base station 805 may fail to decode the first MAC PDU received at 815 and the MAC layer 804 of the UE 801 may retransmit the first MAC PDU at 816. In another example, the MAC layer 806 of the base station 805 may fail to decode the last MAC PDU received at 835 and the MAC layer 804 of the UE 801 may retransmit the last MAC PDU at 836.

Here, the MAC layer 806 of the base station 805 may identify the transmission time T_Start (SFN_tx, SN_tx) as reported by the UE 801. That is, the first MAC PDU transmitted at 815 and retransmitted at 816 may carry the MAC-CE including the transmission time T_Start (SFN_tx, SN_tx), and the base station 805 may decode the first MAC PDU retransmitted at 816 to identify the transmission time T_Start (SFN_tx, SN_tx).

The MAC layer 806 of the base station 805 may transmit at least one RLC PDU to the RLC layer 807 of the base station 805. That is, the MAC layer 806 of the base station 805 may decode the at least one MAC PDU received from the MAC layer 804 of the UE 801 to generate the corresponding at least one RLC PDU, and transmit the at least one RLC PDU to the RLC layer 807 of the base station 805. At 818, 828, and 838, MAC layer 806 of the base station 805 may generate the at least one MAC PDU received at 816, 826, and 836, and transmit the RLC PDU to the RLC layer 807 of the base station 805.

The RLC layer 807 of the base station 805 may transmit the PDCP PDU to the PDCP layer 808 of the base station 805. That is, the RLC layer may generate the PDCP PDU based on the at least one RLC PDU received from the MAC layer 806 of the base station 805, and transmit the PDCP PDU to the PDCP layer 808 of the base station 805. After receiving the last RLC PDU from the MAC layer 806 of the base station 805 at 838, the RLC layer 807 of the base station 805 may generate the PDCP PDU based on the at least one RLC PDU at 818, 828, and 838, and transmit the PDCP PDU to the PDCP layer at 839.

The base station 805 may calculate the UL delay 840 based on at least on the timing information from the UE 801. Here, upon delivery of the PDCP PDU from the RLC layer 807 of the base station 805, the base station 805 may calculate the UL delay 840 on the air interface of the corresponding SDU based on at least the timing information reported by the UE, the timing information including the first wait time 842 received in the PDCP PDU header, the transmission time T_Start received in the first MAC PDU at 816, and a receive time associated with successfully receiving the last MAC PDU associated with the UL data from the UE 801 at 836.

In some aspects, the base station may calculate the UL delay 840 by adding the first wait time 842 indicating the first time difference T_Wait 842 between the arrival time T_Arrival indicating the system time that the SDU arrived at the PDCP layer 802 of the UE 801 and the transmission time T_Start indicating the system time that the first MAC PDU containing UL data of the SDU is transmit to the base station 805 at 815, and a second time difference T_Air 844 between the transmission time T_Start (SFN_tx, SN_tx) indicating the first transmission of the first MAC PDU containing UL data of the SDU at 815 and the receive time associated with successfully receiving the last MAC PDU associated with the UL data from the UE 801 at 836. That is, the base station may calculate the UL delay 840 as T_Wait+T_Air. T_Wait may refer to the first time difference 842 between the arrival time T_Arrival associated with the arrival of the SDU at the PDCP layer 802 of the UE 801 and the transmission time T_Start (SFN_tx, SN_tx) associated with transmitting, to the base station 805, the first MAC PDU containing UL data of the SDU at 815. T_Air may refer to the second time difference 844 between the transmission time T_Start (SFN_tx, SN_tx) associated with the first transmission of the first MAC PDU containing the UL data of the SDU at 815 and the receive time associated with successfully receiving the last MAC PDU associated with the UL data from the UE 801 at 836.

The first time difference 842 may be reported by the UE 801 in the PDCP PDU. In some aspects, the PDCP PDU may have a particular structure to carry the timing information. That is, the PDCP PDU may have a header configured to include the timing information. Here, the timing information may include the first wait time T_Wait 842 associated with a first time difference between an arrival time T_Arrival associated with the arrival of the SDU at the PDCP layer 802 of the UE 801 and a transmission time T_Start associated with transmitting, to the base station 805, the first MAC PDU containing UL data of the SDU at 815. The UE 801 may include the first wait time T_Wait 842 in the PDCP PDU header, and the base station 805 may identify the first wait time T_Wait 842 as the UE 801 reported in the PDCP PDU header.

The transmission time T_Start (SFN_tx, SN_tx) may be reported by the UE 801 in the first MAC PDU. In one aspect, the MAC-CE including the transmission time T_Start (SFN_tx, SN_tx) may include a dedicated field to carry the transmission time T_Start (SFN_tx, SN_tx). In another aspect, the transmission time T_Start (SFN_tx, SN_tx) may be reported in a buffer status report (BSR). Here, the timing information may include the transmission time T_Start (SFN_tx, SN_tx) associated with the first transmission of the first MAC PDU containing the UL data of the SDU at 815. The UE 801 may include the transmission time T_Start (SFN_tx, SN_tx) in the first MAC PDU, and the base station 805 may identify the transmission time T_Start (SFN_tx, SN_tx) as the UE 801 reported in the first MAC PDU.

The base station 805 may calculate the second time difference T_Air 844 between the first transmission of the first MAC PDU containing UL data of the SDU at 815 and the receive time associated with successfully receiving the last MAC PDU associated with the UL data from the UE 801 at 836. In one aspect, the base station 805 may identify the successful reception of the last MAC PDU associated with the UL data from the UE 801 at 836. That is, the base station 805 may identify the receive time indicating the system time corresponding to successfully receiving, from the UE 801, the last MAC PDU containing the UL data of the SDU at 836. In one example, the receive time (SFN_rx, SN_rx) may indicate the receive time that the last MAC PDU associated with the UL data was successfully received at the MAC layer 806 of the base station 805, where SFN_rx is a system frame number and SN_rx is a slot number of the system time that the last MAC PDU associated with the UL data was successfully received at the MAC layer 806 of the base station 805 from the MAC layer 804 of the UE 801. That is, the base station 805 may calculate the second time different T_Air 844 as (SFN_rx,SN_rx)−(SFN_tx,SN_tx), where (SFN_tx, SN_tx) is the transmission time T_Start associated with the first transmission of the first MAC PDU containing the UL data of the SDU at 815, and (SFN_rx,SN_rx) is the receive time indicating the system time of the successful reception of the last MAC PDU that carries data from the SDU.

In some aspects, the PDCP PDU may have a particular structure to carry the timing information. That is, the PDCP PDU may have a header configured to include the timing information. Here, the timing information may include the first wait time T_Wait 842 indicating the first time difference between an arrival time T_Arrival associated with the arrival of the SDU at the PDCP layer 802 of the UE 801 and the transmission time T_Start (SFN_tx,SN_tx) associated with transmitting, to the base station 805, the first MAC PDU containing UL data of the SDU at 815, and the PDCP PDU header may be configured to carry the first wait time T_Wait 842. The UE 801 may include the first wait time T_Wait 842 in the PDCP PDU header, and the base station 805 may identify the first wait time T_Wait 842 as the UE 801 reported in the PDCP PDU header.

In some aspects, the first MAC PDU transmitted at 815 and retransmitted at 816 may include the transmission time T_Start (SFN_tx, SN_tx) associated with the first transmission of the first MAC PDU containing UL data of the SDU at 815. In one aspect, the MAC-CE including the transmission time T_Start (SFN_tx, SN_tx) may include a dedicated field to carry the transmission time T_Start (SFN_tx, SN_tx). In another aspect, the transmission time T_Start (SFN_tx, SN_tx) may be reported in a buffer status report (BSR). The UE 801 may include the transmission time T_Start (SFN_tx, SN_tx) in the first MAC PDU, and the base station 805 may decode the first MAC PDU to identify the transmission time T_Start (SFN_tx, SN_tx) as the UE 801 reported in the first MAC PDU.

In one aspect, the UE 801 may be configured to know or receive the instruction of the transmission opportunity of the first MAC PDU to calculate or generate the first wait time T_Wait 842, and the UE 801 may receive, from the base station 805, the UL DCI including the instruction of the first transmission opportunity of the first MAC PDU. Accordingly, the UE 801 may generate the first wait time T_Wait 842 after receiving, from the base station 805, the UL DCI including the instruction of the first transmission opportunity of the first MAC PDU, and the UE 801 may build the PDCP PDU header after calculating the first wait time T_Wait 842 after receiving the UL DCI to include the first wait time T_Wait 842 in the PDCP PDU header.

Compared to the call-flow diagram 600 of FIG. 6, the base station 805 may not detect when the 1st HARQ transmission of the 1st MAC PDU took place, which may be complicate for the base station 805 to detect. That is, the base station 805 may be configured to determining the fourth time difference T_Air_2 844 based on the receive time associated with successfully receiving the last MAC PDU associated with the UL data from the UE 801 at 836 and the second wait time T_Wait_2 842 and the header time T_Header (SFN_he, SN_he) reported from the UE 801.

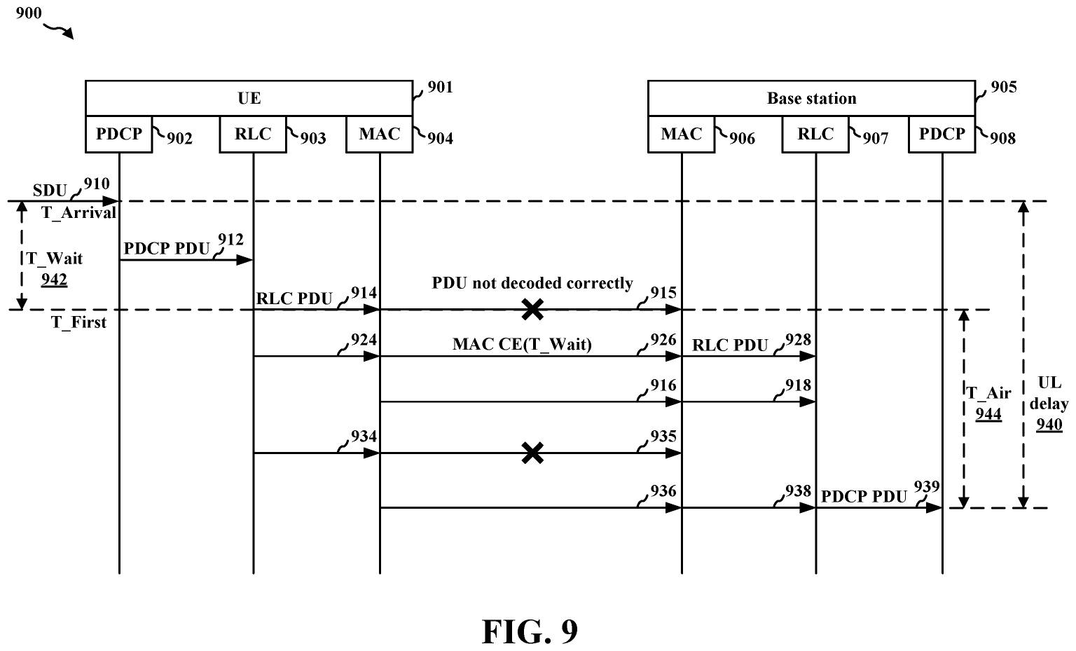

FIG. 9 is a call-flow chart of a method of wireless communication. The call-flow diagram 900 may include a UE 901 including a PDCP layer 902, an RLC layer 903, and a MAC layer, and a base station 905 including a MAC layer 906, an RLC layer 907, and a PDCP layer 908. In some aspects, the timing information may include a first wait time T_Wait 942 associated with a first time difference between an arrival time T_Arrival associated with the arrival of the SDU at the PDCP layer 902 of the UE 901 and a transmission time T_Start associated with transmitting, to the base station 905, the first MAC PDU containing UL data of the SDU at 915.

At 910, the UE 901 may receive the SDU from a higher layer, e.g., the application layer, including UL data to be transmitted to the base station 905. Here, the first wait time 942 may be the first time difference T_Wait 942 between the arrival time T_Arrival indicating the system time that the SDU arrived at the PDCP layer 902 of the UE 901 and the transmission time T_Start indicating the system time that the first MAC PDU containing UL data of the SDU is transmit to the base station 905 at 915. That is, the UE 901 may calculate the first wait time 942 between the arrival time T_Arrival indicating the system time that the SDU arrived at the PDCP layer 902 of the UE 901 and the transmission time T_Start indicating the system time that the first MAC PDU containing UL data of the SDU is transmit to the base station 905 at 915, and report the first wait time 942 to the base station 905 in the PDCP PDU.

At 912, a PDCP PDU may be transmitted from the PDCP layer 902 of the UE 901 to the RLC layer 903 of the UE 901. That is, the PDCP layer 902 of the UE 901 may generate the PDCP PDU based on the SDU received at 910 from the higher layer, and transmit the PDCP PDU to the RLC layer 903 of the UE 901.

The RLC layer 903 of the UE 901 may transmit at least one RLC PDU to the MAC layer 904 of the UE 901 based on the PDCP PDU received from the PDCP layer 902 of the UE 901. That is, the RLC layer 903 of the UE 901 may generate the at least one RLC PDU based on the PDCP PDU received from the PDCP layer 902 of the UE 901, and transmit the RLC PDU to the MAC layer 904 of the UE 901 for the MAC layer 904 of the UE 901. At 914, 924, and 934, the RLC layer 903 of the UE 901 may transmit at least one RLC PDU to the MAC layer 904 of the UE 901. At 914, the RLC layer 903 of the UE 901 may generate the first RLC PDU based on the PDCP PDU received from the PDCP layer 902 of the UE 901 at 912. At 934, the RLC layer 903 of the UE 901 may generate the last RLC PDU based on the PDCP PDU received from the PDCP layer 902 of the UE 901 at 912.

The MAC layer 904 of the UE 901 may transmit at least one MAC PDU to the MAC layer 906 of the base station 905. That is, the MAC layer 904 of the UE 901 may generate the at least one MAC PDU based on the at least one RLC PDU received from the RLC layer 903 of the UE 901. In one aspect, the MAC PDU 904 of the UE 901 may be transmitted to the base station 905 through a lower layer, e.g., a physical layer, using transport channels of the lower layer. At 915, 916, 926, 935, and 936, the MAC layer 904 of the UE 901 may transmit or retransmit at least one MAC PDU to the MAC layer 906 of the base station 905. At 915 and 916, the MAC layer 904 of the UE 901 may transmit or retransmit the first MAC PDU to the MAC layer 906 of the base station 905. At 935 and 936, the MAC layer 904 of the UE 901 may transmit or retransmit the last MAC PDU to the MAC layer 906 of the base station 905.

Here, the MAC layer 904 of the UE 901 may include the first wait time 942 between the arrival time T_Arrival indicating the system time that the SDU arrived at the PDCP layer 902 of the UE 901 and the transmission time T_Start indicating the system time that the first MAC PDU containing UL data of the SDU is transmit to the base station 905 at 915. That is, the first MAC PDU transmitted at 915 and retransmitted at 916 may carry the MAC-CE including the first wait time T_Wait 942. In one aspect, the MAC-CE including the first wait time T_Wait 942 may include a dedicated field to carry the first wait time T_Wait 942. In another aspect, the first wait time T_Wait 942 may be reported in a buffer status report (BSR).

The MAC layer 906 of the base station 905 may decode the at least one MAC PDU received from the MAC layer 904 of the UE 901. In some aspects, the MAC layer 906 of the base station 905 may fail to decode a MAC PDU received from the MAC layer 904 of the UE 901, and the MAC layer 904 of the UE 901 may perform a retransmission of the MAC PDU that the MAC layer 906 of the base station 905 failed to decode. In one aspect, the MAC layer 906 of the base station 905 may transmit a feedback to the MAC layer 904 of the UE 901 to indicate that the MAC PDU was not successfully transmitted and request a retransmission of the MAC PDU. At 916 and 936, the MAC layer 904 of the UE 901 may retransmit the MAC PDUs transmitted at 915 and 935. In one example, the MAC layer 906 of the base station 905 may fail to decode the first MAC PDU received at 915 and the MAC layer 904 of the UE 901 may retransmit the first MAC PDU at 916. In another example, the MAC layer 906 of the base station 905 may fail to decode the last MAC PDU received at 935 and the MAC layer 904 of the UE 901 may retransmit the last MAC PDU at 936.

Here, the MAC layer 906 of the base station 905 may identify the first wait time T_Wait 942 as reported by the UE 901. That is, the first MAC PDU transmitted at 915 and retransmitted at 916 may carry the MAC-CE including the first wait time T_Wait 942, and the base station 905 may decode the first MAC PDU retransmitted at 916 to identify the first wait time T_Wait 942.

The MAC layer 906 of the base station 905 may transmit at least one RLC PDU to the RLC layer 907 of the base station 905. That is, the MAC layer 906 of the base station 905 may decode the at least one MAC PDU received from the MAC layer 904 of the UE 901 to generate the corresponding at least one RLC PDU, and transmit the at least one RLC PDU to the RLC layer 907 of the base station 905. At 918, 928, and 938, MAC layer 906 of the base station 905 may generate the at least one MAC PDU received at 916, 926, and 936, and transmit the RLC PDU to the RLC layer 907 of the base station 905.

The RLC layer 907 of the base station 905 may transmit the PDCP PDU to the PDCP layer 908 of the base station 905. That is, the RLC layer may generate the PDCP PDU based on the at least one RLC PDU received from the MAC layer 906 of the base station 905, and transmit the PDCP PDU to the PDCP layer 908 of the base station 905. After receiving the last RLC PDU from the MAC layer 906 of the base station 905 at 938, the RLC layer 907 of the base station 905 may generate the PDCP PDU based on the at least one RLC PDU at 918, 928, and 938, and transmit the PDCP PDU to the PDCP layer at 939.

The base station 905 may calculate the UL delay 940 based on at least on the timing information from the UE 901. Here, upon delivery of the PDCP PDU from the RLC layer 907 of the base station 905, the base station 905 may calculate the UL delay 940 on the air interface of the corresponding SDU based on at least the timing information reported by the UE, the timing information including the first wait time 942, the transmission time T_Start associated with transmitting, to the base station 905, the first MAC PDU containing UL data of the SDU at 915, and a receive time associated with successfully receiving the last MAC PDU associated with the UL data from the UE 901 at 936.

In some aspects, the base station may calculate the UL delay 940 by adding the first wait time 942 indicating the first time difference T_Wait 942 between the arrival time T_Arrival indicating the system time that the SDU arrived at the PDCP layer 902 of the UE 901 and the transmission time T_Start indicating the system time that the first MAC PDU containing UL data of the SDU is transmit to the base station 905 at 915, and a second time difference T_Air 944 between a transmission of the first MAC PDU containing UL data of the SDU at 915 and the receive time associated with successfully receiving the last MAC PDU associated with the UL data from the UE 901 at 936. That is, the base station may calculate the UL delay 940 as T_Wait+T_Air. T_Wait may refer to the first time difference 942 between the arrival time T_Arrival associated with the arrival of the SDU at the PDCP layer 902 of the UE 901 and the transmission time T_Start associated with transmitting, to the base station 905, the first MAC PDU containing UL data of the SDU at 915. T_Air may refer to the second time difference 944 between the first transmission of the first MAC PDU containing the UL data of the SDU at 915 and the receive time associated with successfully receiving the last MAC PDU associated with the UL data from the UE 901 at 936.

The first wait time T_Wait 942 indicating the first time difference 942 may be reported by the UE 901 in the first MAC PDU. In one aspect, the MAC-CE including the first wait time T_Wait 942 may include a dedicated field to carry the transmission time T_Start (SFN_tx, SN_tx). In another aspect, the first wait time T_Wait 942 may be reported in a buffer status report (BSR). Here, the timing information may include the first wait time T_Wait 942 associated with the first time difference between an arrival time T_Arrival associated with the arrival of the SDU at the PDCP layer 902 of the UE 901 and the transmission time T_Start associated with the first transmission of the first MAC PDU containing UL data of the SDU at 915. The UE 901 may include the first wait time T_Wait 942 in the first MAC PDU, and the base station 905 may identify the first wait time T_Wait 942 as the UE 901 reported in the first MAC PDU.

The base station 905 may calculate the second time difference T_Air 944 between the first transmission of the first MAC PDU containing UL data of the SDU at 915 and the receive time associated with successfully receiving the last MAC PDU associated with the UL data from the UE 901 at 936. In one aspect, the base station 905 may identify the transmission time T_Start associated with transmitting, to the base station 905, the first MAC PDU containing the UL data of the SDU at 915. That is, the base station 905 may identify the transmission time T_Start indicating the system time corresponding to first attempt to receive, from the UE 901, the first MAC PDU containing UL data of the SDU at 915. In another aspect, the base station 905 may identify the successful reception of the last MAC PDU associated with the UL data from the UE 901 at 936. That is, the base station 905 may identify the receive time indicating the system time corresponding to successfully receiving, from the UE 901, the last MAC PDU containing the UL data of the SDU at 936.

In some aspects, the first MAC PDU transmitted at 915 and retransmitted at 916 may include the first wait time T_Wait 942 associated with the first time difference between an arrival time T_Arrival associated with the arrival of the SDU at the PDCP layer 902 of the UE 901 and the transmission time T_Start associated with the first transmission of the first MAC PDU containing UL data of the SDU at 915. In one aspect, the MAC-CE including the first wait time T_Wait 942 may include a dedicated field to carry the transmission time T_Start (SFN_tx, SN_tx). In another aspect, the first wait time T_Wait 942 may be reported in a buffer status report (BSR). The UE 901 may include the first wait time T_Wait 942 in the first MAC PDU, and the base station 905 may decode the first MAC PDU to identify the first wait time T_Wait 942 as the UE 901 reported in the first MAC PDU.

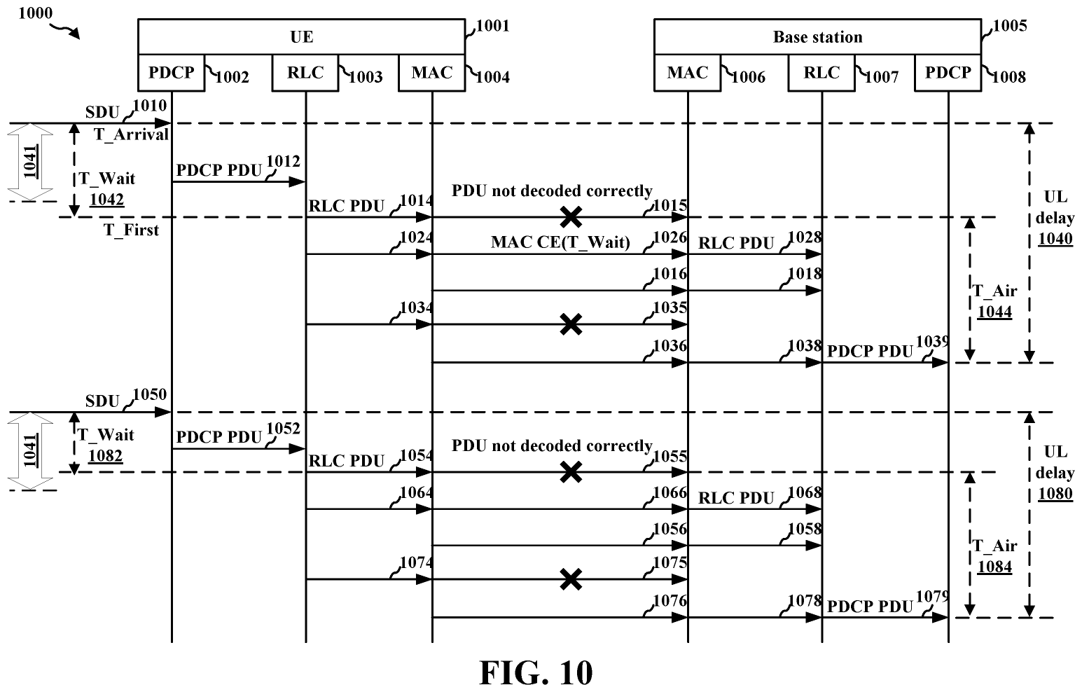

FIG. 10 is a call-flow chart of a method of wireless communication. The call-flow diagram 1000 may include a UE 1001 including a PDCP layer 1002, an RLC layer 1003, and a MAC layer, and a base station 1005 including a MAC layer 1006, an RLC layer 1007, and a PDCP layer 1008. In some aspects, the timing information may include a first wait time T_Wait 1042 associated with a first time difference between an arrival time T_Arrival associated with the arrival of the SDU at the PDCP layer 1002 of the UE 1001 and a transmission time T_Start associated with transmitting, to the base station 1005, the first MAC PDU containing UL data of the SDU at 1015.

In some aspects, the transmission of the first MAC PDU including the MAC-CE or the BSR indicating the first wait time T_Wait 1042 may be configured to be conditional to a threshold value 1041. That is, the UE 1001 may compare the first wait time T_Wait 1042 with the threshold value 1041, and determine to report the first wait time T_Wait 1042 in the first MAC PDU based on the outcome of the comparison. In one aspect, the UE 1001 may be configured to report the first wait time T_Wait 1042 in the first MAC PDU based on the first wait time T_Wait 1042 being great than or equal to the threshold value 1041. The base station may receive the first wait time T_Wait 1042 from the UE 1001, and calculate the UL delay 1040. In another aspect, the UE 1001 may be configured to not report the first wait time T_Wait 1042 in the first MAC PDU based on the first wait time T_Wait 1042 being great than or equal to the threshold value 1041. In one aspect, the UE 1001 may receive an RRC message from the base station 1005, the RRC message instructing the UE 1001 to transmit the MAC-CE or the BSR conditional to the threshold value 1041.

At 1010, the UE 1001 may receive the SDU from a higher layer, e.g., the application layer, including UL data to be transmitted to the base station 1005. Here, the first wait time 1042 may be the first time difference T_Wait 1042 between the arrival time T_Arrival indicating the system time that the SDU arrived at the PDCP layer 1002 of the UE 1001 and the transmission time T_Start indicating the system time that the first MAC PDU containing UL data of the SDU is transmit to the base station 1005 at 1015. That is, the UE 1001 may calculate the first wait time 1042 between the arrival time T_Arrival indicating the system time that the SDU arrived at the PDCP layer 1002 of the UE 1001 and the transmission time T_Start indicating the system time that the first MAC PDU containing UL data of the SDU is transmit to the base station 1005 at 1015.

At 1012, a PDCP PDU may be transmitted from the PDCP layer 1002 of the UE 1001 to the RLC layer 1003 of the UE 1001. That is, the PDCP layer 1002 of the UE 1001 may generate the PDCP PDU based on the SDU received at 1010 from the higher layer, and transmit the PDCP PDU to the RLC layer 1003 of the UE 1001.

The RLC layer 1003 of the UE 1001 may transmit at least one RLC PDU to the MAC layer 1004 of the UE 1001 based on the PDCP PDU received from the PDCP layer 1002 of the UE 1001. That is, the RLC layer 1003 of the UE 1001 may generate the at least one RLC PDU based on the PDCP PDU received from the PDCP layer 1002 of the UE 1001, and transmit the RLC PDU to the MAC layer 1004 of the UE 1001 for the MAC layer 1004 of the UE 1001. At 1014, 1024, and 1034, the RLC layer 1003 of the UE 1001 may transmit at least one RLC PDU to the MAC layer 1004 of the UE 1001. At 1014, the RLC layer 1003 of the UE 1001 may generate the first RLC PDU based on the PDCP PDU received from the PDCP layer 1002 of the UE 1001 at 1012. At 1034, the RLC layer 1003 of the UE 1001 may generate the last RLC PDU based on the PDCP PDU received from the PDCP layer 1002 of the UE 1001 at 1012.

The MAC layer 1004 of the UE 1001 may transmit at least one MAC PDU to the MAC layer 1006 of the base station 1005. That is, the MAC layer 1004 of the UE 1001 may generate the at least one MAC PDU based on the at least one RLC PDU received from the RLC layer 1003 of the UE 1001. In one aspect, the MAC PDU 1004 of the UE 1001 may be transmitted to the base station 1005 through a lower layer, e.g., a physical layer, using transport channels of the lower layer. At 1015, 1016, 1026, 1035 and 1036, the MAC layer 1004 of the UE 1001 may transmit or retransmit at least one MAC PDU to the MAC layer 1006 of the base station 1005. At 1015 and 1016, the MAC layer 1004 of the UE 1001 may transmit or retransmit the first MAC PDU to the MAC layer 1006 of the base station 1005. At 1035 and 1036, the MAC layer 1004 of the UE 1001 may transmit or retransmit the last MAC PDU to the MAC layer 1006 of the base station 1005.

The UE 1001 may compare the first wait time T_Wait 1042 with the threshold value 1041 to determine whether to report, to the base station 1005, the first wait time T_Wait 1042 in the first MAC PDU. Here, the UE 1001 may determine that the first wait time T_Wait 1042 is greater than or equal to the threshold value 1041. Accordingly, the UE 1001 may determine to report, to the base station 1005, the first wait time T_Wait 1042 in the first MAC PDU transmitted at 1015 or retransmitted at 1016. The MAC layer 1004 of the UE 1001 may include the first wait time 1042 between the arrival time T_Arrival indicating the system time that the SDU arrived at the PDCP layer 1002 of the UE 1001 and the transmission time T_Start indicating the system time that the first MAC PDU containing UL data of the SDU is transmit to the base station 1005 at 1015. That is, the first MAC PDU transmitted at 1015 and retransmitted at 1016 may carry the MAC-CE including the first wait time T_Wait 1042. In one aspect, the MAC-CE including the first wait time T_Wait 1042 may include a dedicated field to carry the first wait time T_Wait 1042. In another aspect, the first wait time T_Wait 1042 may be reported in a buffer status report (BSR).

The MAC layer 1006 of the base station 1005 may decode the at least one MAC PDU received from the MAC layer 1004 of the UE 1001. In some aspects, the MAC layer 1006 of the base station 1005 may fail to decode a MAC PDU received from the MAC layer 1004 of the UE 1001, and the MAC layer 1004 of the UE 1001 may perform a retransmission of the MAC PDU that the MAC layer 1006 of the base station 1005 failed to decode. In one aspect, the MAC layer 1006 of the base station 1005 may transmit a feedback to the MAC layer 1004 of the UE 1001 to indicate that the MAC PDU was not successfully transmitted and request a retransmission of the MAC PDU. At 1016 and 1036, the MAC layer 1004 of the UE 1001 may retransmit the MAC PDUs transmitted at 1015 and 1035. In one example, the MAC layer 1006 of the base station 1005 may fail to decode the first MAC PDU received at 1015 and the MAC layer 1004 of the UE 1001 may retransmit the first MAC PDU at 1016. In another example, the MAC layer 1006 of the base station 1005 may fail to decode the last MAC PDU received at 1035 and the MAC layer 1004 of the UE 1001 may retransmit the last MAC PDU at 1036.

Here, the MAC layer 1006 of the base station 1005 may identify the first wait time T_Wait 1042 as reported by the UE 1001. That is, the first MAC PDU transmitted at 1015 and retransmitted at 1016 may include the first wait time T_Wait 1042 associated with the first time difference between an arrival time T_Arrival associated with the arrival of the SDU at the PDCP layer 1002 of the UE 1001 and the transmission time T_Start associated with the first transmission of the first MAC PDU containing UL data of the SDU at 1015. The first MAC PDU transmitted at 1015 and retransmitted at 1016 may carry the MAC-CE including the first wait time T_Wait 1042, and the base station 1005 may decode the first MAC PDU retransmitted at 1016 to identify the first wait time T_Wait 1042.

The MAC layer 1006 of the base station 1005 may transmit at least one RLC PDU to the RLC layer 1007 of the base station 1005. That is, the MAC layer 1006 of the base station 1005 may decode the at least one MAC PDU received from the MAC layer 1004 of the UE 1001 to generate the corresponding at least one RLC PDU, and transmit the at least one RLC PDU to the RLC layer 1007 of the base station 1005. At 1018, 1028, and 1028, MAC layer 1006 of the base station 1005 may generate the at least one MAC PDU received at 1016, 1026, and 1036, and transmit the RLC PDU to the RLC layer 1007 of the base station 1005.

The RLC layer 1007 of the base station 1005 may transmit the PDCP PDU to the PDCP layer 1008 of the base station 1005. That is, the RLC layer may generate the PDCP PDU based on the at least one RLC PDU received from the MAC layer 1006 of the base station 1005, and transmit the PDCP PDU to the PDCP layer 1008 of the base station 1005. After receiving the last RLC PDU from the MAC layer 1006 of the base station 1005 at 1038, the RLC layer 1007 of the base station 1005 may generate the PDCP PDU based on the at least one RLC PDU at 1018, 1028, and 1038, and transmit the PDCP PDU to the PDCP layer at 1039.

The base station 1005 may calculate the UL delay 1040 based on at least on the timing information from the UE 1001. Here, upon delivery of the PDCP PDU from the RLC layer 1007 of the base station 1005, the base station 1005 may calculate the UL delay 1040 on the air interface of the corresponding SDU based on at least the timing information reported by the UE, the timing information including the first wait time 1042, the transmission time T_Start associated with transmitting, to the base station 1005, the first MAC PDU containing UL data of the SDU at 1015, and a receive time associated with successfully receiving the last MAC PDU associated with the UL data from the UE 1001 at 1036.

In some aspects, the base station may calculate the UL delay 1040 by adding the first wait time 1042 indicating the first time difference T_Wait 1042 between the arrival time T_Arrival indicating the system time that the SDU arrived at the PDCP layer 1002 of the UE 1001 and the transmission time T_Start indicating the system time that the first MAC PDU containing UL data of the SDU is transmit to the base station 1005 at 1015, and a second time difference T_Air 1044 between the first transmission of the first MAC PDU containing UL data of the SDU at 1015 and the receive time associated with successfully receiving the last MAC PDU associated with the UL data from the UE 1001 at 1036. That is, the base station may calculate the UL delay 1040 as T_Wait+T_Air. T_Wait may refer to the first time difference 1042 between the arrival time T_Arrival associated with the arrival of the SDU at the PDCP layer 1002 of the UE 1001 and the transmission time T_Start associated with transmitting, to the base station 1005, the first MAC PDU containing UL data of the SDU at 1015. T_Air may refer to the second time difference 1044 between the first transmission of the first MAC PDU containing the UL data of the SDU at 1015 and the receive time associated with successfully receiving the last MAC PDU associated with the UL data from the UE 1001 at 1036.

The first wait time T_Wait 1042 indicating the first time difference 1042 may be reported by the UE 1001 in the first MAC PDU. In one aspect, the MAC-CE including the first wait time T_Wait 1042 may include a dedicated field to carry the transmission time T_Start (SFN_tx, SN_tx). In another aspect, the first wait time T_Wait 1042 may be reported in a buffer status report (BSR). Here, the timing information may include the first wait time T_Wait 1042 associated with the first time difference between an arrival time T_Arrival associated with the arrival of the SDU at the PDCP layer 1002 of the UE 1001 and the transmission time T_Start associated with the first transmission of the first MAC PDU containing UL data of the SDU at 1015. The UE 1001 may include the first wait time T_Wait 1042 in the first MAC PDU, and the base station 1005 may identify the first wait time T_Wait 1042 as the UE 1001 reported in the first MAC PDU.

The base station 1005 may calculate the second time difference T_Air 1044 between the first transmission of the first MAC PDU containing UL data of the SDU at 1015 and the receive time associated with successfully receiving the last MAC PDU associated with the UL data from the UE 1001 at 1036. In one aspect, the base station 1005 may identify the transmission time T_Start associated with transmitting, to the base station 1005, the first MAC PDU containing the UL data of the SDU at 1015. That is, the base station 1005 may identify the transmission time T_Start indicating the system time corresponding to first attempt to receive, from the UE 1001, the first MAC PDU containing UL data of the SDU at 1015. In another aspect, the base station 1005 may identify the successful reception of the last MAC PDU associated with the UL data from the UE 1001 at 1036. That is, the base station 1005 may identify the receive time indicating the system time corresponding to successfully receiving, from the UE 1001, the last MAC PDU containing the UL data of the SDU at 1036.

At 1050, the UE 1001 may receive the SDU from a higher layer, e.g., the application layer, including UL data to be transmitted to the base station 1005. Here, the first wait time 1082 may be the first time difference T_Wait 1082 between the arrival time T_Arrival indicating the system time that the SDU arrived at the PDCP layer 1002 of the UE 1001 and the transmission time T_Start indicating the system time that the first MAC PDU containing UL data of the SDU is transmit to the base station 1005 at 1055. At 1052, the PDCP layer 1002 of the UE 1001 may generate the PDCP PDU based on the SDU received at 1050 from the higher layer, and transmit the PDCP PDU to the RLC layer 1003 of the UE 1001.

The RLC layer 1003 of the UE 1001 may transmit at least one RLC PDU to the MAC layer 1004 of the UE 1001 based on the PDCP PDU received from the PDCP layer 1002 of the UE 1001. That is, the RLC layer 1003 of the UE 1001 may generate the at least one RLC PDU based on the PDCP PDU received from the PDCP layer 1002 of the UE 1001, and transmit the RLC PDU to the MAC layer 1004 of the UE 1001 for the MAC layer 1004 of the UE 1001. At 1054, 1064, and 1074, the RLC layer 1003 of the UE 1001 may transmit at least one RLC PDU to the MAC layer 1004 of the UE 1001. At 1054, the RLC layer 1003 of the UE 1001 may generate the first RLC PDU based on the PDCP PDU received from the PDCP layer 1002 of the UE 1001 at 1052. At 1074, the RLC layer 1003 of the UE 1001 may generate the last RLC PDU based on the PDCP PDU received from the PDCP layer 1002 of the UE 1001 at 1052.

The MAC layer 1004 of the UE 1001 may transmit at least one MAC PDU to the MAC layer 1006 of the base station 1005. That is, the MAC layer 1004 of the UE 1001 may generate the at least one MAC PDU based on the at least one RLC PDU received from the RLC layer 1003 of the UE 1001. In one aspect, the MAC PDU 1004 of the UE 1001 may be transmitted to the base station 1005 through a lower layer, e.g., a physical layer, using transport channels of the lower layer. At 1055, 1056, 1066, 1075, and 1076, the MAC layer 1004 of the UE 1001 may transmit or retransmit at least one MAC PDU to the MAC layer 1006 of the base station 1005. At 1055 and 1056, the MAC layer 1004 of the UE 1001 may transmit or retransmit the first MAC PDU to the MAC layer 1006 of the base station 1005. At 1075 and 1076, the MAC layer 1004 of the UE 1001 may transmit and retransmit the last MAC PDU to the MAC layer 1006 of the base station 1005.

The UE 1001 may compare the first wait time T_Wait 1082 with the threshold value 1041 to determine whether to report, to the base station 1005, the first wait time T_Wait 1082 in the first MAC PDU. Here, the UE 1001 may determine that the first wait time T_Wait 1082 is less than the threshold value 1041. Accordingly, the UE 1001 may determine not to report the first wait time T_Wait 1082 to the base station 1005. That is, the first MAC PDU transmitted at 1055 and retransmitted at 1056 may not carry the MAC-CE including the first wait time T_Wait 1082.

The MAC layer 1006 of the base station 1005 may decode the at least one MAC PDU received from the MAC layer 1004 of the UE 1001. In some aspects, the MAC layer 1006 of the base station 1005 may fail to decode a MAC PDU received from the MAC layer 1004 of the UE 1001, and the MAC layer 1004 of the UE 1001 may perform a retransmission of the MAC PDU that the MAC layer 1006 of the base station 1005 failed to decode. In one aspect, the MAC layer 1006 of the base station 1005 may transmit a feedback to the MAC layer 1004 of the UE 1001 to indicate that the MAC PDU was not successfully transmitted and request a retransmission of the MAC PDU. At 1056 and 1076, the MAC layer 1004 of the UE 1001 may retransmit the MAC PDUs transmitted at 1055 and 1075. In one example, the MAC layer 1006 of the base station 1005 may fail to decode the first MAC PDU received at 1055 and the MAC layer 1004 of the UE 1001 may retransmit the first MAC PDU at 1056. In another example, the MAC layer 1006 of the base station 1005 may fail to decode the last MAC PDU received at 1075 and the MAC layer 1004 of the UE 1001 may retransmit the last MAC PDU at 1076.

Here, the MAC layer 1006 of the base station 1005 may identify that the UE 1001 did not report the first wait time T_Wait 1082. That is, based on determining that the first wait time T_Wait 1082 is less than the threshold value 1041, the first MAC PDU transmitted at 1015 and retransmitted at 1016 may not include the first wait time T_Wait 1082. Based on the identifying that the decoded first MAC PDU does not include the first wait time T_Wait 1082, the base station 1005 may determine that the first wait time T_Wait 1082 is less than the threshold value 1041.

The MAC layer 1006 of the base station 1005 may transmit at least one RLC PDU to the RLC layer 1007 of the base station 1005. That is, the MAC layer 1006 of the base station 1005 may decode the at least one MAC PDU received from the MAC layer 1004 of the UE 1001 to generate the corresponding at least one RLC PDU, and transmit the at least one RLC PDU to the RLC layer 1007 of the base station 1005. At 1058, 1068, and 1068, MAC layer 1006 of the base station 1005 may generate the at least one MAC PDU received at 1056, 1066, and 1076, and transmit the RLC PDU to the RLC layer 1007 of the base station 1005.

The RLC layer 1007 of the base station 1005 may transmit the PDCP PDU to the PDCP layer 1008 of the base station 1005. That is, the RLC layer may generate the PDCP PDU based on the at least one RLC PDU received from the MAC layer 1006 of the base station 1005, and transmit the PDCP PDU to the PDCP layer 1008 of the base station 1005. After receiving the last RLC PDU from the MAC layer 1006 of the base station 1005 at 1078, the RLC layer 1007 of the base station 1005 may generate the PDCP PDU based on the at least one RLC PDU at 1058, 1068, and 1078, and transmit the PDCP PDU to the PDCP layer at 1079.

The base station 1005 may calculate the UL delay 1080 based on at least on the timing information from the UE 1001. Here, since the UE 1001 did not report the first wait time T_Wait 1082, the base station 1005 may identify that the first wait time T_Wait 1082 is less than the threshold value 1041. That is, upon the delivery of the PDCP PDU from the RLC layer 1007 of the base station 1005, the base station 1005 may determine the UL delay 1080 on the air interface of the corresponding SDU based on lack of the timing information reported by the UE and a receive time associated with successfully receiving the last MAC PDU associated with the UL data from the UE 1001 at 1076. In one aspect, the base station 1005 may identify a second time difference T_Air 1084 between the first transmission of the first MAC PDU containing UL data of the SDU at 1055 and the receive time associated with successfully receiving the last MAC PDU associated with the UL data from the UE 1001 at 1036. Based on determining that the UE 1001 did not report the first wait time T_Wait 1082, the base station 1005 may determine that the UL delay 1080 is less than an added value of the threshold value 1041 and the second time difference T_Air 1084. That is, the base station may determine that the UL delay 1080<T_Thresh+T_Air. T_Thresh may refer to the threshold value 1041 between the arrival time T_Arrival associated with the arrival of the SDU at the PDCP layer 1002 of the UE 1001 and the transmission time T_Start associated with transmitting, to the base station 1005, the first MAC PDU containing UL data of the SDU for the first time at 1055.

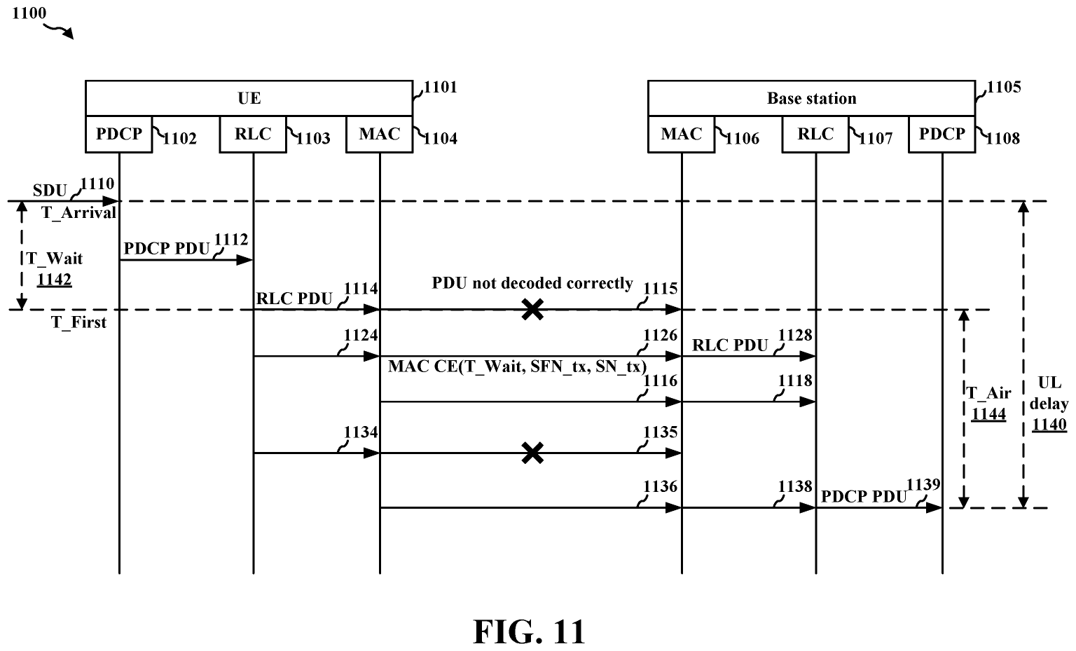

FIG. 11 is a call-flow chart of a method of wireless communication. The call-flow diagram 1100 may include a UE 1101 including a PDCP layer 1102, an RLC layer 1103, and a MAC layer, and a base station 1105 including a MAC layer 1106, an RLC layer 1107, and a PDCP layer 1108. In some aspects, the timing information may include a first wait time T_Wait 1142 associated with a first time difference between an arrival time T_Arrival associated with the arrival of the SDU at the PDCP layer 1102 of the UE 1101 and a transmission time T_Start associated with transmitting, to the base station 1105, the first MAC PDU containing UL data of the SDU at 1115.

At 1110, the UE 1101 may receive the SDU from a higher layer, e.g., the application layer, including UL data to be transmitted to the base station 1105. Here, the first wait time 1142 may be the first time difference T_Wait 1142 between the arrival time T_Arrival indicating the system time that the SDU arrived at the PDCP layer 1102 of the UE 1101 and the transmission time T_Start indicating the system time that the first MAC PDU containing UL data of the SDU is transmit to the base station 1105 at 1115. That is, the UE 1101 may calculate the first wait time 1142 between the arrival time T_Arrival indicating the system time that the SDU arrived at the PDCP layer 1102 of the UE 1101 and the transmission time T_Start indicating the system time that the first MAC PDU containing UL data of the SDU is transmit to the base station 1105 at 1115.

At 1112, a PDCP PDU may be transmitted from the PDCP layer 1102 of the UE 1101 to the RLC layer 1103 of the UE 1101. That is, the PDCP layer 1102 of the UE 1101 may generate the PDCP PDU based on the SDU received at 1110 from the higher layer, and transmit the PDCP PDU to the RLC layer 1103 of the UE 1101.

The RLC layer 1103 of the UE 1101 may transmit at least one RLC PDU to the MAC layer 1104 of the UE 1101 based on the PDCP PDU received from the PDCP layer 1102 of the UE 1101. That is, the RLC layer 1103 of the UE 1101 may generate the at least one RLC PDU based on the PDCP PDU received from the PDCP layer 1102 of the UE 1101, and transmit the RLC PDU to the MAC layer 1104 of the UE 1101 for the MAC layer 1104 of the UE 1101. At 1114, 1124, and 1134, the RLC layer 1103 of the UE 1101 may transmit at least one RLC PDU to the MAC layer 1104 of the UE 1101. At 1114, the RLC layer 1103 of the UE 1101 may generate the first RLC PDU based on the PDCP PDU received from the PDCP layer 1102 of the UE 1101 at 1112. At 1134, the RLC layer 1103 of the UE 1101 may generate the last RLC PDU based on the PDCP PDU received from the PDCP layer 1102 of the UE 1101 at 1112.

The MAC layer 1104 of the UE 1101 may transmit at least one MAC PDU to the MAC layer 1106 of the base station 1105. That is, the MAC layer 1104 of the UE 1101 may generate the at least one MAC PDU based on the at least one RLC PDU received from the RLC layer 1103 of the UE 1101. In one aspect, the MAC PDU 1104 of the UE 1101 may be transmitted to the base station 1105 through a lower layer, e.g., a physical layer, using transport channels of the lower layer. At 1115, 1116, 1126, 1135, and 1136, the MAC layer 1104 of the UE 1101 may transmit or retransmit at least one MAC PDU to the MAC layer 1106 of the base station 1105. At 1115 and 1116, the MAC layer 1104 of the UE 1101 may transmit or retransmit the first MAC PDU to the MAC layer 1106 of the base station 1105. At 1135 and 1136, the MAC layer 1104 of the UE 1101 may transmit or retransmit the last MAC PDU to the MAC layer 1106 of the base station 1105.

Here, the MAC layer 1104 of the UE 1101 may include the transmission time T_Start indicating the system time that the first MAC PDU containing UL data of the SDU is transmit to the base station 1105 and the first wait time T_Wait 1142 between the arrival time T_Arrival indicating the system time that the SDU arrived at the PDCP layer 1102 of the UE 1101 and the transmission time T_Start. That is, the first MAC PDU transmitted at 1115 and retransmitted at 1116 may carry the MAC-CE including the first wait time T_Wait 1142 and the transmission time T_Start. In one example, the first MAC PDU transmitted at 1115 and retransmitted at 1116 may carry the MAC-CE including the first wait time T_Wait 1142 and the transmission time T_Start (SFN_tx, SN_tx), where SFN_tx is a system frame number and SN_tx is a slot number of the system time that the first MAC PDU containing UL data of the SDU is transmit to the base station 1105. In one aspect, the MAC-CE including the first wait time T_Wait 1142 and the transmission time T_Start (SFN_tx, SN_tx) may include a dedicated field to carry the transmission time T_Start (SFN_tx, SN_tx). In another aspect, the first wait time T_Wait 1142 and the transmission time T_Start (SFN_tx, SN_tx) may be reported in a buffer status report (BSR).

The MAC layer 1106 of the base station 1105 may decode the at least one MAC PDU received from the MAC layer 1104 of the UE 1101. In some aspects, the MAC layer 1106 of the base station 1105 may fail to decode a MAC PDU received from the MAC layer 1104 of the UE 1101, and the MAC layer 1104 of the UE 1101 may perform a retransmission of the MAC PDU that the MAC layer 1106 of the base station 1105 failed to decode. In one aspect, the MAC layer 1106 of the base station 1105 may transmit a feedback to the MAC layer 1104 of the UE 1101 to indicate that the MAC PDU was not successfully transmitted and request a retransmission of the MAC PDU. At 1116 and 1136, the MAC layer 1104 of the UE 1101 may retransmit the MAC PDUs transmitted at 1115 and 1135. In one example, the MAC layer 1106 of the base station 1105 may fail to decode the first MAC PDU received at 1115 and the MAC layer 1104 of the UE 1101 may retransmit the first MAC PDU at 1116. In another example, the MAC layer 1106 of the base station 1105 may fail to decode the last MAC PDU received at 1135 and the MAC layer 1104 of the UE 1101 may retransmit the last MAC PDU at 1136.

Here, the MAC layer 1106 of the base station 1105 may identify the first wait time T_Wait 1142 and the transmission time T_Start (SFN_tx, SN_tx) as reported by the UE 1101. That is, the first MAC PDU transmitted at 1115 and retransmitted at 1116 may carry the MAC-CE including the first wait time T_Wait 1142 and the transmission time T_Start (SFN_tx, SN_tx), and the base station 1105 may decode the first MAC PDU retransmitted at 1116 to identify the first wait time T_Wait 1142 and the transmission time T_Start (SFN_tx, SN_tx).

The MAC layer 1106 of the base station 1105 may transmit at least one RLC PDU to the RLC layer 1107 of the base station 1105. That is, the MAC layer 1106 of the base station 1105 may decode the at least one MAC PDU received from the MAC layer 1104 of the UE 1101 to generate the corresponding at least one RLC PDU, and transmit the at least one RLC PDU to the RLC layer 1107 of the base station 1105. At 1118, 1128, and 1138, MAC layer 1106 of the base station 1105 may generate the at least one MAC PDU received at 1116, 1126, and 1136, and transmit the RLC PDU to the RLC layer 1107 of the base station 1105.

The RLC layer 1107 of the base station 1105 may transmit the PDCP PDU to the PDCP layer 1108 of the base station 1105. That is, the RLC layer may generate the PDCP PDU based on the at least one RLC PDU received from the MAC layer 1106 of the base station 1105, and transmit the PDCP PDU to the PDCP layer 1108 of the base station 1105. After receiving the last RLC PDU from the MAC layer 1106 of the base station 1105 at 1138, the RLC layer 1107 of the base station 1105 may generate the PDCP PDU based on the at least one RLC PDU at 1118, 1128, and 1138, and transmit the PDCP PDU to the PDCP layer at 1139.

The base station 1105 may calculate the UL delay 1140 based on at least on the timing information from the UE 1101. Here, upon delivery of the PDCP PDU from the RLC layer 1107 of the base station 1105, the base station 1105 may calculate the UL delay 1140 on the air interface of the corresponding SDU based on at least the timing information reported by the UE, the timing information including the first wait time 1142 and the transmission time T_Start received in the first MAC PDU at 1116, and a receive time associated with successfully receiving the last MAC PDU associated with the UL data from the UE 1101 at 1136.

In some aspects, the base station may calculate the UL delay 1140 by adding the first wait time 1142 indicating the first time difference T_Wait 1142 between the arrival time T_Arrival indicating the system time that the SDU arrived at the PDCP layer 1102 of the UE 1101 and the transmission time T_Start indicating the system time that the first MAC PDU containing UL data of the SDU is transmit to the base station 1105 at 1115, and a second time difference T_Air 1144 between the transmission time T_Start (SFN_tx, SN_tx) indicating the first transmission of the first MAC PDU containing UL data of the SDU at 1115 and the receive time associated with successfully receiving the last MAC PDU associated with the UL data from the UE 1101 at 1136. That is, the base station may calculate the UL delay 1140 as T_Wait+T_Air. T_Wait may refer to the first time difference 1142 between the arrival time T_Arrival associated with the arrival of the SDU at the PDCP layer 1102 of the UE 1101 and the transmission time T_Start (SFN_tx, SN_tx) associated with transmitting, to the base station 1105, the first MAC PDU containing UL data of the SDU at 1115. T_Air may refer to the second time difference 1144 between the transmission time T_Start (SFN_tx, SN_tx) associated with the first transmission of the first MAC PDU containing the UL data of the SDU at 1115 and the receive time associated with successfully receiving the last MAC PDU associated with the UL data from the UE 1101 at 1136.

The first wait time T_Wait 1142 and the transmission time T_Start (SFN_tx, SN_tx) may be reported by the UE 1101 in the first MAC PDU. In one aspect, the MAC-CE including the first wait time T_Wait 1142 and the transmission time T_Start (SFN_tx, SN_tx) may include a dedicated field to carry the first wait time T_Wait 1142 and the transmission time T_Start (SFN_tx, SN_tx). In another aspect, the first wait time T_Wait 1142 and the transmission time T_Start (SFN_tx, SN_tx) may be reported in a buffer status report (BSR). Here, the timing information may include the transmission time T_Start (SFN_tx, SN_tx) associated with the first transmission of the first MAC PDU containing the UL data of the SDU at 1115. The UE 1101 may include the first wait time T_Wait 1142 and the transmission time T_Start (SFN_tx, SN_tx) in the first MAC PDU, and the base station 1105 may identify the first wait time T_Wait 1142 and the transmission time T_Start (SFN_tx, SN_tx) as the UE 1101 reported in the first MAC PDU.

The base station 1105 may calculate the second time difference T_Air 1144 between the first transmission of the first MAC PDU containing UL data of the SDU at 1115 and the receive time associated with successfully receiving the last MAC PDU associated with the UL data from the UE 1101 at 1136. In one aspect, the base station 1105 may identify the successful reception of the last MAC PDU associated with the UL data from the UE 1101 at 1136. That is, the base station 1105 may identify the receive time indicating the system time corresponding to successfully receiving, from the UE 1101, the last MAC PDU containing the UL data of the SDU at 1136. In one example, the receive time (SFN_rx, SN_rx) may indicate the receive time that the last MAC PDU associated with the UL data was successfully received at the MAC layer 1106 of the base station 1105, where SFN_rx is a system frame number and SN_rx is a slot number of the system time that the last MAC PDU associated with the UL data was successfully received at the MAC layer 1106 of the base station 1105 from the MAC layer 1104 of the UE 1101. That is, the base station 1105 may calculate the second time different T_Air 1144 as (SFN_rx,SN_rx)−(SFN_tx,SN_tx), where (SFN_tx, SN_tx) is the transmission time T_Start associated with the first transmission of the first MAC PDU containing the UL data of the SDU at 1115, and (SFN_rx,SN_rx) is the receive time indicating the system time of the successful reception of the last MAC PDU that carries data from the SDU.

Compared to the call-flow diagram 600 of FIG. 6, since the first wait time T_Wait 1142 is reported in the first MAC PDU, the UE 1101 may build the PDCP header before initiating the transmission of the first MAC PDU on the air interface. Also, the base station 1105 may not detect when the 1st HARQ transmission of the 1st MAC PDU took place, which may be complicate for the base station 1105 to detect. That is, the base station 1105 may be configured to determining the second time difference T_Air 1144 based on the receive time associated with successfully receiving the last MAC PDU associated with the UL data from the UE 1101 at 1136 and the first wait time T_Wait 1142 and the header time T_Header (SFN_he, SN_he) reported from the UE 1101.

Referring to FIGS. 5, 6, 7, 8, 9, 10, and 11, based on the UL delay calculated or measured based at least in part on the timing information from the UE, the network including the base station may monitor the wireless communication and manage the configuration of the wireless communication according to the UL delay.

The network including the base station may perform the QoS monitoring. That is, the network may use the UL delay to assess whether the QoS of the RTT sensitive traffic is fulfilled. The network including the base station may monitor the UL delay, and compare the UL delay with at least one monitoring threshold value associated with the corresponding traffic to determine whether the QoS of the corresponding traffic meets the condition specified for the corresponding traffic. For example, if the calculated UL delay is greater than a monitoring threshold value specified for the corresponding traffic, the base station may determine that the QoS of the traffic does not meet the specified condition to provide the service associated with the traffic.

In some aspects, the network including the base station may use the metric (e.g., UL delay) to adapt the UL resources (e.g. radio, hardware, or transport) or its scheduling decisions. That is, the network including the base station may configure or schedule and indicate the configuration of the UL resources based on the calculated UL delay. In one aspect, a long UL delay may indicate that the UL resources are undersized or that the cell is overloaded. That is, the network including the base station may increase the size of the UL resources allocated for the corresponding UE based on detecting a long UL delay. For example, the network including the base station may determine that the UL delay is greater than a monitoring threshold value corresponding to the QoS of the traffic, and the network may increase the size of the UL resources allocated for the corresponding UE based on determining that the UL delay is greater than the monitoring threshold value.

In another aspect, the base station may prioritize scheduling based on the UL delay. For example, some traffics, such as traffic associated with the XR, may be more sensitive to the Motion to Render to Photon (M2R2P) and RTT, and may be have higher importance over other traffics, e.g., higher priority. The base station downlink scheduler (e.g. a deadline-aware scheduler) may take advantage of the UL delay of an SDU (e.g., the traffic associated with the tracking/pose information in XR) to handle the priority of the associated downlink SDUs (e.g., the traffic associated with the video frame in XR) accordingly.

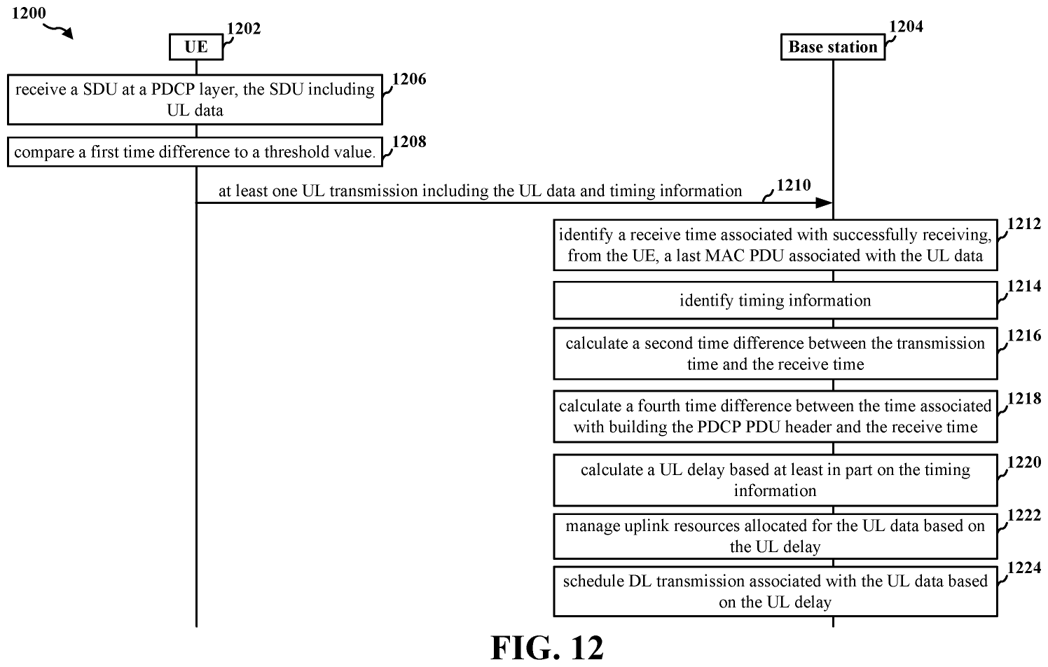

FIG. 12 is a call-flow diagram 1200 of a method of wireless communication. The call-flow diagram 1200 may include a UE 1202 and a base station 1204. The UE 1202 may receive, at a PDCP layer, a SDU including UL data to be transmitted to the base station 1204, and transmit, to the base station 1204, at least one UL transmission including the UL data and timing information associated with an arrival of the SDU at the PDCP layer. The base station 1204 may receive the at least one UL transmission including the UL data, identify timing information, and calculate an UL delay based at least in part on the timing information from the UE 1202. The timing information may be communicated in at least one of a PDCP PDU header or a MAC-CE.

At 1206, the UE 1202 may receive a SDU at a PDCP layer, the SDU including UL data to be transmitted in a PDU. That is, the UE 1202 may receive the SDU from a higher layer, e.g., the application layer, including UL data to be transmitted to the base station 1204. The SDU may include the UL data to be transmitted to the base station 1204. Here, the arrival time may indicate the arrival of the SDU at the PDCP layer of the UE 1202. In one example, the arrival time (SFN_s, SN_s) may indicate the arrival time that the SDU arrive at the PDCP layer of the UE 1202, where SFN_s is a system frame number and SN_s is a slot number of the system time that the SDU arrived at the PDCP layer of the UE 1202 from the higher layer of the UE 1202.

At 1208, the UE 1202 may compare the first time difference to a threshold value. The UE 1202 may transmit the timing information at 1210 based on the first time difference being greater than or equal to the threshold value. That is, the transmission of the first wait time may be conditional to a threshold value, and the UE 1202 may be configured to report the first wait time in the first MAC PDU based on the first wait time being great than or equal to the threshold value. The UE 1202 may receive, from the base station 1204, an RRC message instructing the UE 1202 to transmit the MAC-CE or the BSR conditional to the threshold value.

At 1210, the UE 1202 may transmit, to a base station 1204, at least one UL transmission including the UL data and timing information associated with an arrival of the SDU at the PDCP layer. The base station 1204 may receive, from the UE 1202, at least one UL transmission including an UL data. In some examples, the timing information may include one or more of a SFN and a SN indicating the corresponding system time.

The timing information may be transmitted in at least one of a PDCP PDU header or a MAC PDU including a MAC-CE, the PDCP PDU and the MAC-CE associated with the at least one UL transmission. In one example, the timing information may be transmitted in the PDCP PDU header, and the PDCP PDU may have a particular structure to carry the timing information. That is, the PDCP PDU may have a header configured to include the timing information. In another example, the timing information may be transmitted in the MAC-CE of the first MAC PDU. The timing information may be reported in the MAC-CE including a dedicated field to carry the timing information or a buffer status report (BSR).

In one aspect, the timing information may include an arrival time associated with the arrival of the SDU at the PDCP layer. The arrival time (SFN_s, SN_s) may indicate the arrival time that the SDU arrive at the PDCP layer of the UE 1202, where SFN_s is a system frame number and SN_s is a slot number of the system time that the SDU arrived at the PDCP layer of the UE 1202 from the higher layer of the UE 1202. In one example, the arrival time (SFN_s, SN_s) may be transmitted in the PDCP PDU header (refer to FIG. 5).

In another aspect, the timing information may include a transmission time that the first MAC PDU containing the UL data of the SDU is transmitted to the base station 1204 or a first time difference between the arrival time associated with the arrival of the SDU at the PDCP layer and the transmission time. The transmission time T_Start may be indicated as (SFN_tx, SN_tx), where SFN_tx is a system frame number and SN_tx is a slot number of the system time that the first MAC PDU containing UL data of the SDU is transmit to the base station 1204 (refer to FIGS. 8 and 11). The transmission time may be transmitted in the first MAC PDU (refer to FIGS. 8 and 11). The first time difference (e.g., the first wait time T_Wait) may be calculated from the arrival time (SFN_s, SN_s) to the transmission time T_Start (SFN_tx, SN_tx), e.g., T_Wait=(SFN_tx, SN_tx)−(SFN_s, SN_s) (refer to FIGS. 6, 8, 9, 10, and 11). The first time difference may be transmitted in the PDCP PDU header (refer to FIGS. 6 and 8) or the first MAC PDU (refer to FIGS. 9, 10, and 11).

In another aspect, the timing information may include a header time associated with building the PDCP PDU header or a third time difference between the arrival time associated with the arrival of the SDU at the PDCP layer and the header time. The header time T_Header may be indicated as (SFN_he, SN_he), where SFN_he is a system frame number and SN_he is a slot number of the system time that the PDCP layer of the UE 1202 builds the PDCP PDU header (refer to FIG. 7). The third time difference (e.g., the second wait time T_Wait_2) may be calculated from the arrival time (SFN_s, SN_s) to the header time T_Header (SFN_he, SN_he), e.g., T_Wait_2=(SFN_tx, SN_tx)−(SFN_he, SN_he) (refer to FIG. 7). The third time difference and the header time may be transmitted in the PDCP PDU header (refer to FIG. 7).

The timing information may be transmitted based on the first time difference being greater than or equal to the threshold value. That is, the UE 1202 may be configured to transmit the first wait time conditional to a threshold value, and the UE 1202 may report the first wait time based on the first wait time being great than or equal to the threshold value. The base station 1204 may transmit an RRC message to instruct the UE 1202 to transmit the MAC-CE or the BSR conditional to the threshold value.

At 1212, the base station 1204 may identify a receive time associated with successfully receiving, from the UE 1202, the last MAC PDU associated with the UL data, wherein the UL delay is further based on the receive time. The receive time (SFN_rx, SN_rx) may indicate the receive time that the last MAC PDU associated with the UL data was successfully received at the MAC layer of the base station 1204, where SFN_rx is a system frame number and SN_rx is a slot number of the system time that the last MAC PDU associated with the UL data was successfully received at the MAC layer of the base station 1204 from the MAC layer of the UE 1202.

At 1214, the base station 1204 may identify timing information associated with a SDU arriving at a PDCP layer of the UE 1202, the SDU associated with the UL data. That is, the base station 1204 may identify the transmission time indicating the system time corresponding to first attempt to receive, from the UE 1202, the first MAC PDU containing UL data of the SDU. In one aspect, the UE 1202 may include the transmission time in the first MAC PDU (refer to FIGS. 8 and 11), and the base station 1204 may decode the first MAC PDU to identify the transmission time as reported by the UE 1202. In another aspect, the UE 1202 may not report the transmission time, and the base station 1204 may identify the system time associated with the first attempt to receive, from the UE 1202, the first MAC PDU containing UL data of the SDU.

At 1216, the base station 1204 may calculate a second time difference between the transmission time and the receive time. That is, the base station 1204 may calculate the second time difference from the transmission time to the receive time. The transmission time (SFN_tx, SN_tx) identified at 1214 may include SFN_tx being a system frame number and SN_tx being a slot number of the system time that the first MAC PDU containing UL data of the SDU is transmit to the base station 1204. The receive time (SFN_rx, SN_rx) identified at 1212 may include SFN_rx being a system frame number and SN_rx being a slot number of the system time that the last MAC PDU associated with the UL data was successfully received at the MAC layer of the base station 1204 from the MAC layer of the UE 1202. Accordingly, the second time difference T_Air may be calculated as (SFN_rx, SN_rx)−(SFN_tx, SN_tx).

At 1218, the base station 1204 may calculate a fourth time difference between the header time associated with building the PDCP PDU header and the receive time. That is, the base station 1204 may calculate the fourth time difference from the header time to the receive time. The header time (SFN_he, SN_he) may be reported by the UE 1202 as the time information, and include SFN_he being a system frame number and SN_he being a slot number of the system time that the PDCP layer of the UE 1202 builds the PDCP PDU header (refer to FIG. 7). The receive time (SFN_rx, SN_rx) identified at 1212 may include SFN_rx being a system frame number and SN_rx being a slot number of the system time that the last MAC PDU associated with the UL data was successfully received at the MAC layer of the base station 1204 from the MAC layer of the UE 1202. Accordingly, the fourth time difference T_Air_2 may be calculated as (SFN_rx, SN_rx)−(SFN_he, SN_he).

At 1220, the base station 1204 may calculate an UL delay based at least in part on the timing information from the UE 1202. The timing information may include at least one of an arrival time associated with the arrival of the SDU at the PDCP layer, a transmission time that the first MAC PDU containing the UL data of the SDU is transmitted to the base station 1204, a header time associated with building the PDCP PDU header, a first time difference between the arrival time and the transmission time, or a third time difference between the arrival time and the header time.

In one aspect, the UL delay may be calculated between the arrival time and the receive time. The timing information received from the UE 1202 may include the arrival time (SFN_s, SN_s), indicating the arrival time that the SDU arrive at the PDCP layer of the UE 1202, where SFN_s is a system frame number and SN_s is a slot number of the system time that the SDU arrived at the PDCP layer of the UE 1202 from the higher layer of the UE 1202. The base station 1204 may calculate the UL delay from the arrival time (SFN_s, SN_s) to the receive time (SFN_rx, SN_rx) identified at 1212. Accordingly, the UL delay may be calculated as (SFN_rx, SN_rx)−(SFN_s, SN_s).

In another aspect, the UL delay may be calculated based on a first time difference and a second time difference, where the first time difference, e.g., the first wait time T_Wait, being between an arrival time associated with an arrival of the SDU at the PDCP layer of the UE 1202 and a transmission time when the UE 1202 transmitted, to the base station 1204, a first MAC PDU containing the UL data of the SDU, and the second time difference, T_Air, calculated at 1216. That is, the base station 1204 may calculate the UL delay as the sum of the first time difference T_Wait and the second time difference T_Air calculated as (SFN_rx, SN_rx)−(SFN_tx, SN_tx) at 1216, e.g., T_Wait+(SFN_rx, SN_rx)−(SFN_tx, SN_tx).

In another aspect, the UL delay is calculated based on the third time difference and the fourth time difference, where the third time difference, e.g., the second wait time T_Wait_2, being between an arrival time associated with the arrival of the SDU at the PDCP layer and a time associated with building the PDCP PDU header, and the fourth time difference, T_Air_2, calculated at 1218. That is, the base station 1204 may calculate the UL delay as the sum of the third difference T_Wait_2 and the fourth time difference T_Air_2 calculated as (SFN_rx, SN_rx)−(SFN_he, SN_he) at 1218, e.g., T_Wait_2+(SFN_rx, SN_rx)−(SFN_he, SN_he).

Based on the UL delay calculated or measured based at least in part on the timing information from the UE 1202, the network including the base station 1204 may monitor the wireless communication and manage the configuration of the wireless communication according to the UL delay. The network including the base station 1204 may perform the QoS monitoring based on the UL delay. That is, the network may use the UL delay to assess whether the QoS of the RTT sensitive traffic is fulfilled. The network including the base station 1204 may monitor the UL delay, and compare the UL delay with at least one threshold value associated with the corresponding traffic to determine whether the QoS of the corresponding traffic meets the condition specified for the corresponding traffic. For example, if the calculated UL delay is greater than a threshold value specified for the corresponding traffic, the base station 1204 may determine that the QoS of the traffic does not meet the specified condition to provide the service associated with the traffic. The network including the base station 1204 may use the metric (e.g., UL delay) to adapt the UL resources (e.g. radio, hardware, or transport) or its scheduling decisions. That is, since a long UL delay may indicate that the UL resources are undersized or that the cell is overloaded, the network including the base station 1204 may configure or schedule and indicate the configuration of the UL resources based on the calculated UL delay.

At 1222, the base station 1204 may manage UL resources allocated for the UL data based on the UL delay. That is, the base station 1204 may increase the size of the UL resources allocated for the corresponding UE 1202 based on detecting a long UL delay, the long UL delay being greater than or equal to the monitoring threshold value. For example, the network including the base station 1204 may determine that the UL delay is greater than a monitoring threshold value corresponding to the QoS of the traffic, and the network may increase the size of the UL resources allocated for the corresponding UE 1202 based on the UL delay being greater than the monitoring threshold value.

At 1224, the base station 1204 may schedule DL transmission associated with the UL data based on the UL delay. That is, the base station 1204 may prioritize scheduling based on the UL delay. For example, some traffics, such as traffic associated with the XR, may be more sensitive to the Motion to Render to Photon (M2R2P) and RTT, and may be have higher importance over other traffics, e.g., higher priority. The base station downlink scheduler (e.g. a deadline-aware scheduler) may take advantage of the UL delay of an SDU (e.g., the traffic associated with the tracking/pose information in XR) to handle the priority of the associated downlink SDUs (e.g., the traffic associated with the video frame in XR) accordingly.

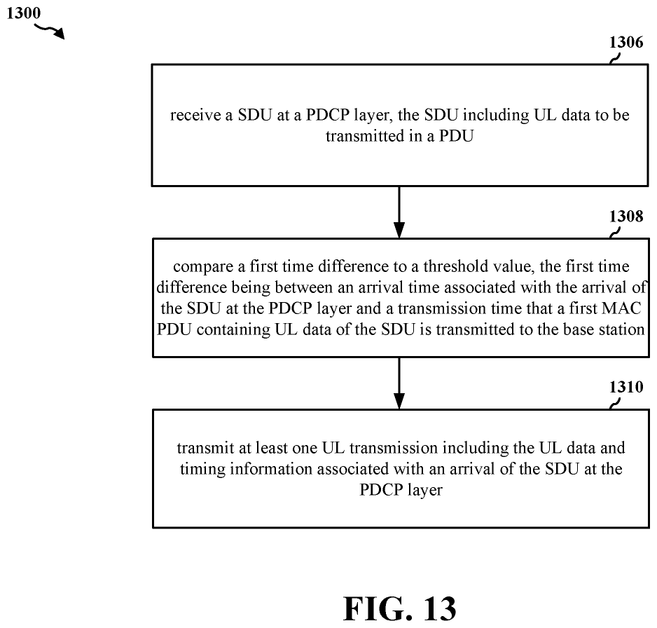

FIG. 13 is a flowchart 1300 of a method of wireless communication. The method may be performed by a UE (e.g., the UE 108; the apparatus 1702). The UE may receive, at a PDCP layer, a SDU including UL data to be transmitted to a base station, and transmit, to the base station, at least one UL transmission including the UL data and timing information associated with an arrival of the SDU at the PDCP layer. The timing information may be communicated in at least one of a PDCP PDU header or a MAC-CE.

At 1306, the UE may receive a SDU at a PDCP layer, the SDU including UL data to be transmitted in a PDU. That is, the UE may receive the SDU from a higher layer, e.g., the application layer, including UL data to be transmitted to the base station. The SDU may include the UL data to be transmitted to the base station. Here, the arrival time may indicate the arrival of the SDU at the PDCP layer of the UE. In one example, the arrival time (SFN_s, SN_s) may indicate the arrival time that the SDU arrive at the PDCP layer of the UE, where SFN_s is a system frame number and SN_s is a slot number of the system time that the SDU arrived at the PDCP layer of the UE from the higher layer of the UE. For example, at 1206, the UE 1202 may receive a SDU at a PDCP layer, the SDU including UL data to be transmitted in a PDU. Furthermore, 1306 may be performed by a timing information component 1740.

At 1308, the UE may compare the first time difference to a threshold value. The UE may transmit the timing information at 1310 based on the first time difference being greater than or equal to the threshold value. That is, the transmission of the first wait time may be conditional to a threshold value, and the UE may be configured to report the first wait time in the first MAC PDU based on the first wait time being great than or equal to the threshold value. The UE may receive, from the base station, an RRC message instructing the UE to transmit the MAC-CE or the BSR conditional to the threshold value. For example, at 1208, the UE 1202 may compare the first time difference to a threshold value. Furthermore, 1308 may be performed by a timing information component 1740.

At 1310, the UE may transmit, to a base station, at least one UL transmission including the UL data and timing information associated with an arrival of the SDU at the PDCP layer. In some examples, the timing information may include one or more of a SFN and a SN indicating the corresponding system time. For example, at 1210, the UE 1202 may transmit, to a base station 1204, at least one UL transmission including the UL data and timing information associated with an arrival of the SDU at the PDCP layer. Furthermore, 1310 may be performed by an UL transmission component 1742.

The timing information may be transmitted in at least one of a PDCP PDU header or a MAC PDU including a MAC-CE, the PDCP PDU and the MAC-CE associated with the at least one UL transmission. In one example, the timing information may be transmitted in the PDCP PDU header, and the PDCP PDU may have a particular structure to carry the timing information. That is, the PDCP PDU may have a header configured to include the timing information. In another example, the timing information may be transmitted in the MAC-CE of the first MAC PDU. The timing information may be reported in the MAC-CE including a dedicated field to carry the timing information or a buffer status report (BSR).

In one aspect, the timing information may include an arrival time associated with the arrival of the SDU at the PDCP layer. The arrival time (SFN_s, SN_s) may indicate the arrival time that the SDU arrive at the PDCP layer of the UE, where SFN_s is a system frame number and SN_s is a slot number of the system time that the SDU arrived at the PDCP layer of the UE from the higher layer of the UE. In one example, the arrival time (SFN_s, SN_s) may be transmitted in the PDCP PDU header (refer to FIG. 5).

In another aspect, the timing information may include a transmission time that the first MAC PDU containing the UL data of the SDU is transmitted to the base station or a first time difference between the arrival time associated with the arrival of the SDU at the PDCP layer and the transmission time. The transmission time T_Start may be indicated as (SFN_tx, SN_tx), where SFN_tx is a system frame number and SN_tx is a slot number of the system time that the first MAC PDU containing UL data of the SDU is transmit to the base station (refer to FIGS. 8 and 11). The transmission time may be transmitted in the first MAC PDU (refer to FIGS. 8 and 11). The first time difference (e.g., the first wait time T_Wait) may be calculated from the arrival time (SFN_s, SN_s) to the transmission time T_Start (SFN_tx, SN_tx), e.g., T_Wait=(SFN_tx, SN_tx)−(SFN_s, SN_s) (refer to FIGS. 6, 8, 9, 10, and 11). The first time difference may be transmitted in the PDCP PDU header (refer to FIGS. 6 and 8) or the first MAC PDU (refer to FIGS. 9, 10, and 11).

In another aspect, the timing information may include a header time associated with building the PDCP PDU header or a third time difference between the arrival time associated with the arrival of the SDU at the PDCP layer and the header time. The header time T_Header may be indicated as (SFN_he, SN_he), where SFN_he is a system frame number and SN_he is a slot number of the system time that the PDCP layer of the UE builds the PDCP PDU header (refer to FIG. 7). The third time difference (e.g., the second wait time T_Wait_2) may be calculated from the arrival time (SFN_s, SN_s) to the header time T_Header (SFN_he, SN_he), e.g., T_Wait_2=(SFN_tx, SN_tx)−(SFN_he, SN_he) (refer to FIG. 7). The third time difference and the header time may be transmitted in the PDCP PDU header (refer to FIG. 7).

The timing information may be transmitted based on the first time difference being greater than or equal to the threshold value. That is, the UE may be configured to transmit the first wait time conditional to a threshold value, and the UE may report the first wait time based on the first wait time being great than or equal to the threshold value. The base station may transmit an RRC message to instruct the UE to transmit the MAC-CE or the BSR conditional to the threshold value.

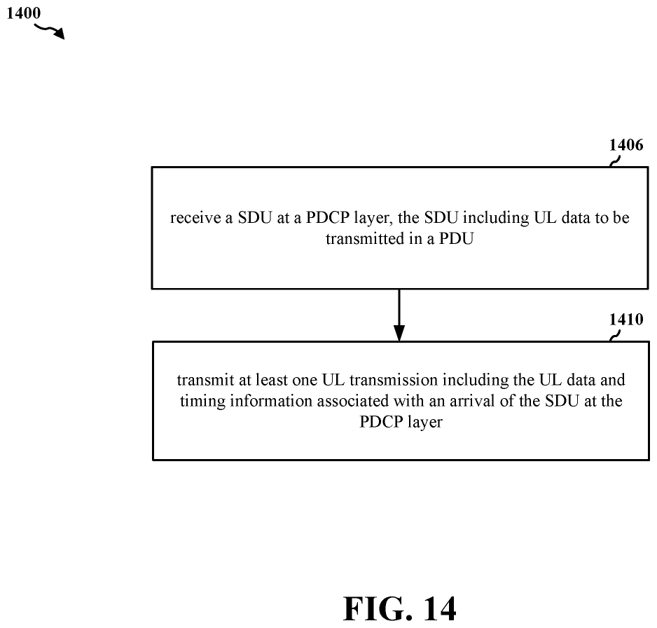

FIG. 14 is a flowchart 1400 of a method of wireless communication. The method may be performed by a UE (e.g., the UE 108; the apparatus 1702). The UE may receive, at a PDCP layer, a SDU including UL data to be transmitted to a base station, and transmit, to the base station, at least one UL transmission including the UL data and timing information associated with an arrival of the SDU at the PDCP layer. The timing information may be communicated in at least one of a PDCP PDU header or a MAC-CE.

At 1406, the UE may receive a SDU at a PDCP layer, the SDU including UL data to be transmitted in a PDU. That is, the UE may receive the SDU from a higher layer, e.g., the application layer, including UL data to be transmitted to the base station. The SDU may include the UL data to be transmitted to the base station. Here, the arrival time may indicate the arrival of the SDU at the PDCP layer of the UE. In one example, the arrival time (SFN_s, SN_s) may indicate the arrival time that the SDU arrive at the PDCP layer of the UE, where SFN_s is a system frame number and SN_s is a slot number of the system time that the SDU arrived at the PDCP layer of the UE from the higher layer of the UE. For example, at 1206, the UE 1202 may receive a SDU at a PDCP layer, the SDU including UL data to be transmitted in a PDU. Furthermore, 1406 may be performed by a timing information component 1740.

At 1410, the UE may transmit, to abase station, at least one UL transmission including the UL data and timing information associated with an arrival of the SDU at the PDCP layer. In some examples, the timing information may include one or more of a SFN and a SN indicating the corresponding system time. For example, at 1210, the UE 1202 may transmit, to a base station 1204, at least one UL transmission including the UL data and timing information associated with an arrival of the SDU at the PDCP layer. Furthermore, 1410 may be performed by an UL transmission component 1742.

The timing information may be transmitted in at least one of a PDCP PDU header or a MAC PDU including a MAC-CE, the PDCP PDU and the MAC-CE associated with the at least one UL transmission. In one example, the timing information may be transmitted in the PDCP PDU header, and the PDCP PDU may have a particular structure to carry the timing information. That is, the PDCP PDU may have a header configured to include the timing information. In another example, the timing information may be transmitted in the MAC-CE of the first MAC PDU. The timing information may be reported in the MAC-CE including a dedicated field to carry the timing information or a buffer status report (BSR).

In one aspect, the timing information may include an arrival time associated with the arrival of the SDU at the PDCP layer. The arrival time (SFN_s, SN_s) may indicate the arrival time that the SDU arrive at the PDCP layer of the UE, where SFN_s is a system frame number and SN_s is a slot number of the system time that the SDU arrived at the PDCP layer of the UE from the higher layer of the UE. In one example, the arrival time (SFN_s, SN_s) may be transmitted in the PDCP PDU header (refer to FIG. 5).

In another aspect, the timing information may include a transmission time that the first MAC PDU containing the UL data of the SDU is transmitted to the base station or a first time difference between the arrival time associated with the arrival of the SDU at the PDCP layer and the transmission time. The transmission time T_Start may be indicated as (SFN_tx, SN_tx), where SFN_tx is a system frame number and SN_tx is a slot number of the system time that the first MAC PDU containing UL data of the SDU is transmit to the base station (refer to FIGS. 8 and 11). The transmission time may be transmitted in the first MAC PDU (refer to FIGS. 8 and 11). The first time difference (e.g., the first wait time T_Wait) may be calculated from the arrival time (SFN_s, SN_s) to the transmission time T_Start (SFN_tx, SN_tx), e.g., T_Wait=(SFN_tx, SN_tx)−(SFN_s, SN_s) (refer to FIGS. 6, 8, 9, 10, and 11). The first time difference may be transmitted in the PDCP PDU header (refer to FIGS. 6 and 8) or the first MAC PDU (refer to FIGS. 9, 10, and 11).

In another aspect, the timing information may include a header time associated with building the PDCP PDU header or a third time difference between the arrival time associated with the arrival of the SDU at the PDCP layer and the header time. The header time T_Header may be indicated as (SFN_he, SN_he), where SFN_he is a system frame number and SN_he is a slot number of the system time that the PDCP layer of the UE builds the PDCP PDU header (refer to FIG. 7). The third time difference (e.g., the second wait time T_Wait_2) may be calculated from the arrival time (SFN_s, SN_s) to the header time T_Header (SFN_he, SN_he), e.g., T_Wait_2=(SFN_tx, SN_tx)−(SFN_he, SN_he) (refer to FIG. 7). The third time difference and the header time may be transmitted in the PDCP PDU header (refer to FIG. 7).

The timing information may be transmitted based on the first time difference being greater than or equal to the threshold value. That is, the UE may be configured to transmit the first wait time conditional to a threshold value, and the UE may report the first wait time based on the first wait time being great than or equal to the threshold value. The base station may transmit an RRC message to instruct the UE to transmit the MAC-CE or the BSR conditional to the threshold value.

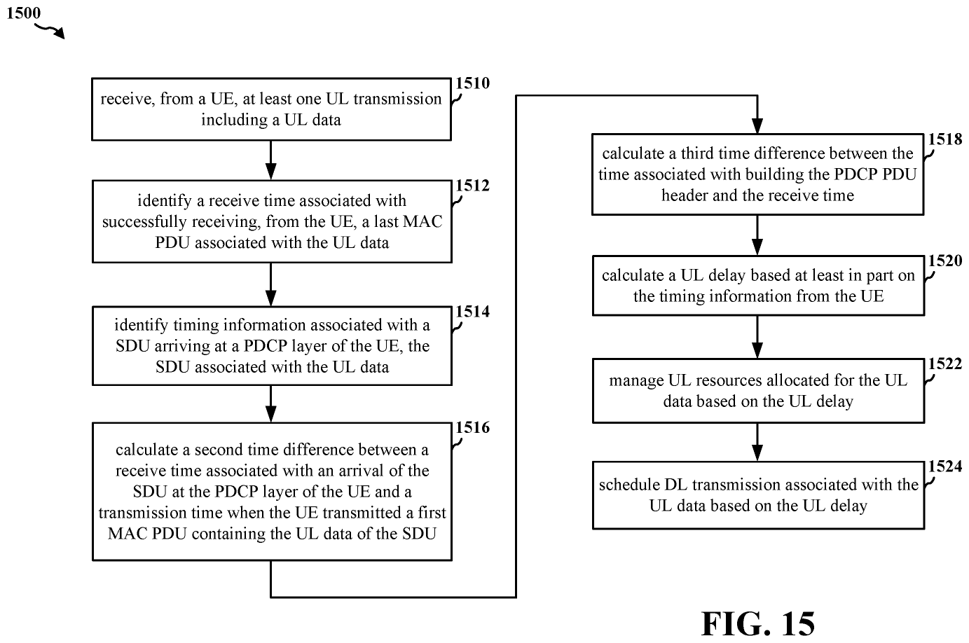

FIG. 15 is a flowchart 1500 of a method of wireless communication. The method may be performed by a base station (e.g., the base station 102/180; the apparatus 1802). The base station may receive the at least one UL transmission including the UL data, identify timing information, and calculate an UL delay based at least in part on the timing information from the UE. The timing information may be communicated in at least one of a PDCP PDU header or a MAC-CE.

At 1510, the base station may receive, from the UE, at least one UL transmission including an UL data. In some examples, the timing information may include one or more of a SFN and a SN indicating the corresponding system time. For example, at 1210, the base station 1204 may receive, from the UE 1202, at least one UL transmission including an UL data. Furthermore, 1510 may be performed by an UL reception component 1840.

The timing information may be transmitted in at least one of a PDCP PDU header or a MAC PDU including a MAC-CE, the PDCP PDU and the MAC-CE associated with the at least one UL transmission. In one example, the timing information may be transmitted in the PDCP PDU header, and the PDCP PDU may have a particular structure to carry the timing information. That is, the PDCP PDU may have a header configured to include the timing information. In another example, the timing information may be transmitted in the MAC-CE of the first MAC PDU. The timing information may be reported in the MAC-CE including a dedicated field to carry the timing information or a buffer status report (BSR).

In one aspect, the timing information may include an arrival time associated with the arrival of the SDU at the PDCP layer. The arrival time (SFN_s, SN_s) may indicate the arrival time that the SDU arrive at the PDCP layer of the UE, where SFN_s is a system frame number and SN_s is a slot number of the system time that the SDU arrived at the PDCP layer of the UE from the higher layer of the UE. In one example, the arrival time (SFN_s, SN_s) may be transmitted in the PDCP PDU header (refer to FIG. 5).

In another aspect, the timing information may include a transmission time that the first MAC PDU containing the UL data of the SDU is transmitted to the base station or a first time difference between the arrival time associated with the arrival of the SDU at the PDCP layer and the transmission time. The transmission time T_Start may be indicated as (SFN_tx, SN_tx), where SFN_tx is a system frame number and SN_tx is a slot number of the system time that the first MAC PDU containing UL data of the SDU is transmit to the base station (refer to FIGS. 8 and 11). The transmission time may be transmitted in the first MAC PDU (refer to FIGS. 8 and 11). The first time difference (e.g., the first wait time T_Wait) may be calculated from the arrival time (SFN_s, SN_s) to the transmission time T_Start (SFN_tx, SN_tx), e.g., T_Wait=(SFN_tx, SN_tx)−(SFN_s, SN_s) (refer to FIGS. 6, 8, 9, 10, and 11). The first time difference may be transmitted in the PDCP PDU header (refer to FIGS. 6 and 8) or the first MAC PDU (refer to FIGS. 9, 10, and 11).

In another aspect, the timing information may include a header time associated with building the PDCP PDU header or a third time difference between the arrival time associated with the arrival of the SDU at the PDCP layer and the header time. The header time T_Header may be indicated as (SFN_he, SN_he), where SFN_he is a system frame number and SN_he is a slot number of the system time that the PDCP layer of the UE builds the PDCP PDU header (refer to FIG. 7). The third time difference (e.g., the second wait time T_Wait_2) may be calculated from the arrival time (SFN_s, SN_s) to the header time T_Header (SFN_he, SN_he), e.g., T_Wait_2=(SFN_tx, SN_tx)−(SFN_he, SN_he) (refer to FIG. 7). The third time difference and the header time may be transmitted in the PDCP PDU header (refer to FIG. 7).

The timing information may be transmitted based on the first time difference being greater than or equal to the threshold value. That is, the UE may be configured to transmit the first wait time conditional to a threshold value, and the UE may report the first wait time based on the first wait time being great than or equal to the threshold value. The base station may transmit an RRC message to instruct the UE to transmit the MAC-CE or the BSR conditional to the threshold value.

At 1512, the base station may identify a receive time associated with successfully receiving, from the UE, the last MAC PDU associated with the UL data, wherein the UL delay is further based on the receive time. The receive time (SFN_rx, SN_rx) may indicate the receive time that the last MAC PDU associated with the UL data was successfully received at the MAC layer of the base station, where SFN_rx is a system frame number and SN_rx is a slot number of the system time that the last MAC PDU associated with the UL data was successfully received at the MAC layer of the base station from the MAC layer of the UE. For example, at 1212, the base station 1204 may identify a receive time associated with successfully receiving, from the UE 1202, the last MAC PDU associated with the UL data, wherein the UL delay is further based on the receive time. Furthermore, 1512 may be performed by a timing information identifying component 1842.

At 1514, the base station may identify timing information associated with a SDU arriving at a PDCP layer of the UE, the SDU associated with the UL data. That is, the base station may identify the transmission time indicating the system time corresponding to first attempt to receive, from the UE, the first MAC PDU containing UL data of the SDU. In one aspect, the UE may include the transmission time in the first MAC PDU (refer to FIGS. 8 and 11), and the base station may decode the first MAC PDU to identify the transmission time as reported by the UE. In another aspect, the UE may not report the transmission time, and the base station may identify the system time associated with the first attempt to receive, from the UE, the first MAC PDU containing UL data of the SDU. For example, at 1214, the base station 1204 may identify timing information associated with a SDU arriving at a PDCP layer of the UE 1202, the SDU associated with the UL data. Furthermore, 1514 may be performed by the timing information identifying component 1842.

At 1516, the base station may calculate a second time difference between the transmission time and the receive time. That is, the base station may calculate the second time difference from the transmission time to the receive time. The transmission time (SFN_tx, SN_tx) identified at 1514 may include SFN_tx being a system frame number and SN_tx being a slot number of the system time that the first MAC PDU containing UL data of the SDU is transmit to the base station. The receive time (SFN_rx, SN_rx) identified at 1512 may include SFN_rx being a system frame number and SN_rx being a slot number of the system time that the last MAC PDU associated with the UL data was successfully received at the MAC layer of the base station from the MAC layer of the UE. Accordingly, the second time difference T_Air may be calculated as (SFN_rx, SN_rx)−(SFN_tx, SN_tx). For example, at 1216, the base station 1204 may calculate a second time difference between the transmission time and the receive time. Furthermore, 1516 may be performed by an UL delay calculation component 1844.

At 1518, the base station may calculate a fourth time difference between the header time associated with building the PDCP PDU header and the receive time. That is, the base station may calculate the fourth time difference from the header time to the receive time. The header time (SFN_he, SN_he) may be reported by the UE as the time information, and include SFN_he being a system frame number and SN_he being a slot number of the system time that the PDCP layer of the UE builds the PDCP PDU header (refer to FIG. 7). The receive time (SFN_rx, SN_rx) identified at 1512 may include SFN_rx being a system frame number and SN_rx being a slot number of the system time that the last MAC PDU associated with the UL data was successfully received at the MAC layer of the base station from the MAC layer of the UE. Accordingly, the fourth time difference T_Air_2 may be calculated as (SFN_rx, SN_rx)−(SFN_he, SN_he). For example, at 1218, the base station 1204 may calculate a fourth time difference between the header time associated with building the PDCP PDU header and the receive time. Furthermore, 1518 may be performed by the UL delay calculation component 1844.

At 1520, the base station may calculate an UL delay based at least in part on the timing information from the UE. The timing information may include at least one of an arrival time associated with the arrival of the SDU at the PDCP layer, a transmission time that the first MAC PDU containing the UL data of the SDU is transmitted to the base station, a header time associated with building the PDCP PDU header, a first time difference between the arrival time and the transmission time, or a third time difference between the arrival time and the header time. For example, at 1220, the base station 1204 may calculate an UL delay based at least in part on the timing information from the UE 1202. Furthermore, 1520 may be performed by the UL delay calculation component 1844.

In one aspect, the UL delay may be calculated between the arrival time and the receive time. The timing information received from the UE may include the arrival time (SFN_s, SN_s), indicating the arrival time that the SDU arrive at the PDCP layer of the UE, where SFN_s is a system frame number and SN_s is a slot number of the system time that the SDU arrived at the PDCP layer of the UE from the higher layer of the UE. The base station may calculate the UL delay from the arrival time (SFN_s, SN_s) to the receive time (SFN_rx, SN_rx) identified at 1512. Accordingly, the UL delay may be calculated as (SFN_rx, SN_rx)−(SFN_s, SN_s).

In another aspect, the UL delay may be calculated based on a first time difference and a second time difference, where the first time difference, e.g., the first wait time T_Wait, being between an arrival time associated with an arrival of the SDU at the PDCP layer of the UE and a transmission time when the UE transmitted, to the base station, a first MAC PDU containing the UL data of the SDU, and the second time difference, T_Air, calculated at 1516. That is, the base station may calculate the UL delay as the sum of the first time difference T_Wait and the second time difference T_Air calculated as (SFN_rx, SN_rx)−(SFN_tx, SN_tx) at 1516, e.g., T_Wait+(SFN_rx, SN_rx)−(SFN_tx, SN_tx).

In another aspect, the UL delay is calculated based on the third time difference and the fourth time difference, where the third time difference, e.g., the second wait time T_Wait_2, being between an arrival time associated with the arrival of the SDU at the PDCP layer and a time associated with building the PDCP PDU header, and the fourth time difference, T_Air_2, calculated at 1518. That is, the base station may calculate the UL delay as the sum of the third difference T_Wait_2 and the fourth time difference T_Air_2 calculated as (SFN_rx, SN_rx)−(SFN_he, SN_he) at 1518, e.g., T_Wait_2+(SFN_rx, SN_rx)−(SFN_he, SN_he).

Based on the UL delay calculated or measured based at least in part on the timing information from the UE, the network including the base station may monitor the wireless communication and manage the configuration of the wireless communication according to the UL delay. The network including the base station may perform the QoS monitoring based on the UL delay. That is, the network may use the UL delay to assess whether the QoS of the RTT sensitive traffic is fulfilled. The network including the base station may monitor the UL delay, and compare the UL delay with at least one threshold value associated with the corresponding traffic to determine whether the QoS of the corresponding traffic meets the condition specified for the corresponding traffic. For example, if the calculated UL delay is greater than a threshold value specified for the corresponding traffic, the base station may determine that the QoS of the traffic does not meet the specified condition to provide the service associated with the traffic. The network including the base station may use the metric (e.g., UL delay) to adapt the UL resources (e.g. radio, hardware, or transport) or its scheduling decisions. That is, since a long UL delay may indicate that the UL resources are undersized or that the cell is overloaded, the network including the base station may configure or schedule and indicate the configuration of the UL resources based on the calculated UL delay.

At 1522, the base station may manage UL resources allocated for the UL data based on the UL delay. That is, the base station may increase the size of the UL resources allocated for the corresponding UE based on detecting a long UL delay, the long UL delay being greater than or equal to the monitoring threshold value. For example, the network including the base station may determine that the UL delay is greater than a monitoring threshold value corresponding to the QoS of the traffic, and the network may increase the size of the UL resources allocated for the corresponding UE based on the UL delay being greater than the monitoring threshold value. For example, at 1222, the base station 1204 may manage UL resources allocated for the UL data based on the UL delay. Furthermore, 1522 may be performed by a wireless communication configuring component 1846.

At 1524, the base station may schedule DL transmission associated with the UL data based on the UL delay. That is, the base station may prioritize scheduling based on the UL delay. For example, some traffics, such as traffic associated with the XR, may be more sensitive to the Motion to Render to Photon (M2R2P) and RTT, and may be have higher importance over other traffics, e.g., higher priority. The base station downlink scheduler (e.g. a deadline-aware scheduler) may take advantage of the UL delay of an SDU (e.g., the traffic associated with the tracking/pose information in XR) to handle the priority of the associated downlink SDUs (e.g., the traffic associated with the video frame in XR) accordingly. For example, at 1224, the base station 1204 may schedule DL transmission associated with the UL data based on the UL delay. Furthermore, 1524 may be performed by the wireless communication configuring component 1846.

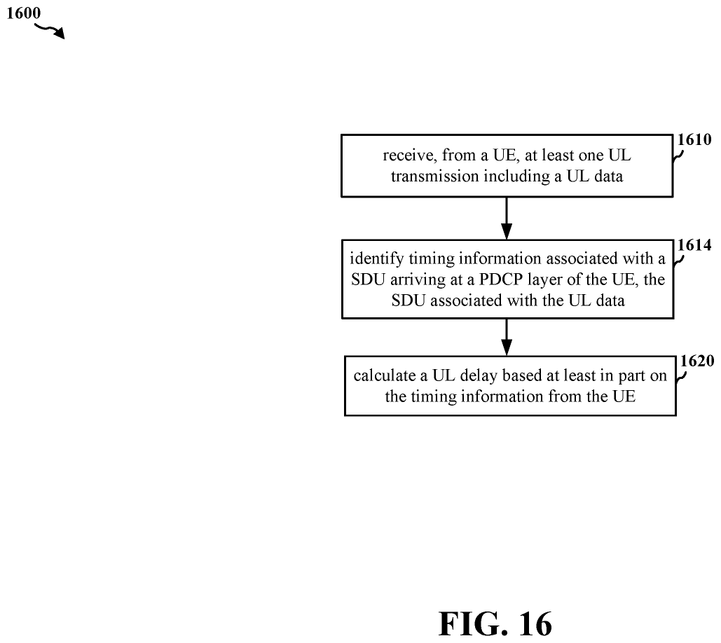

FIG. 16 is a flowchart 1600 of a method of wireless communication. The method may be performed by a base station (e.g., the base station 102/180; the apparatus 1802). The base station may receive the at least one UL transmission including the UL data, identify timing information, and calculate an UL delay based at least in part on the timing information from the UE. The timing information may be communicated in at least one of a PDCP PDU header or a MAC-CE.

At 1610, the base station may receive, from the UE, at least one UL transmission including an UL data. In some examples, the timing information may include one or more of a SFN and a SN indicating the corresponding system time. For example, at 1210, the base station 1204 may receive, from the UE 1202, at least one UL transmission including an UL data. Furthermore, 1610 may be performed by an UL reception component 1840.

The timing information may be transmitted in at least one of a PDCP PDU header or a MAC PDU including a MAC-CE, the PDCP PDU and the MAC-CE associated with the at least one UL transmission. In one example, the timing information may be transmitted in the PDCP PDU header, and the PDCP PDU may have a particular structure to carry the timing information. That is, the PDCP PDU may have a header configured to include the timing information. In another example, the timing information may be transmitted in the MAC-CE of the first MAC PDU. The timing information may be reported in the MAC-CE including a dedicated field to carry the timing information, or a buffer status report (BSR).

In one aspect, the timing information may include an arrival time associated with the arrival of the SDU at the PDCP layer. The arrival time (SFN_s, SN_s) may indicate the arrival time that the SDU arrive at the PDCP layer of the UE, where SFN_s is a system frame number and SN_s is a slot number of the system time that the SDU arrived at the PDCP layer of the UE from the higher layer of the UE. In one example, the arrival time (SFN_s, SN_s) may be transmitted in the PDCP PDU header (refer to FIG. 5).

In another aspect, the timing information may include a transmission time that the first MAC PDU containing the UL data of the SDU is transmitted to the base station or a first time difference between the arrival time associated with the arrival of the SDU at the PDCP layer and the transmission time. The transmission time T_Start may be indicated as (SFN_tx, SN_tx), where SFN_tx is a system frame number and SN_tx is a slot number of the system time that the first MAC PDU containing UL data of the SDU is transmit to the base station (refer to FIGS. 8 and 11). The transmission time may be transmitted in the first MAC PDU (refer to FIGS. 8 and 11). The first time difference (e.g., the first wait time T_Wait) may be calculated from the arrival time (SFN_s, SN_s) to the transmission time T_Start (SFN_tx, SN_tx), e.g., T_Wait=(SFN_tx, SN_tx)−(SFN_s, SN_s) (refer to FIGS. 6, 8, 9, 10, and 11). The first time difference may be transmitted in the PDCP PDU header (refer to FIGS. 6 and 8) or the first MAC PDU (refer to FIGS. 9, 10, and 11).

In another aspect, the timing information may include a header time associated with building the PDCP PDU header or a third time difference between the arrival time associated with the arrival of the SDU at the PDCP layer and the header time. The header time T_Header may be indicated as (SFN_he, SN_he), where SFN_he is a system frame number and SN_he is a slot number of the system time that the PDCP layer of the UE builds the PDCP PDU header (refer to FIG. 7). The third time difference (e.g., the second wait time T_Wait_2) may be calculated from the arrival time (SFN_s, SN_s) to the header time T_Header (SFN_he, SN_he), e.g., T_Wait_2=(SFN_tx, SN_tx)−(SFN_he, SN_he) (refer to FIG. 7). The third time difference and the header time may be transmitted in the PDCP PDU header (refer to FIG. 7).

The timing information may be transmitted based on the first time difference being greater than or equal to the threshold value. That is, the UE may be configured to transmit the first wait time conditional to a threshold value, and the UE may report the first wait time based on the first wait time being great than or equal to the threshold value. The base station may transmit an RRC message to instruct the UE to transmit the MAC-CE or the BSR conditional to the threshold value.

At 1614, the base station may identify timing information associated with a SDU arriving at a PDCP layer of the UE, the SDU associated with the UL data. That is, the base station may identify the transmission time indicating the system time corresponding to first attempt to receive, from the UE, the first MAC PDU containing UL data of the SDU. In one aspect, the UE may include the transmission time in the first MAC PDU (refer to FIGS. 8 and 11), and the base station may decode the first MAC PDU to identify the transmission time as reported by the UE. In another aspect, the UE may not report the transmission time, and the base station may identify the system time associated with the first attempt to receive, from the UE, the first MAC PDU containing UL data of the SDU. For example, at 1214, the base station 1204 may identify timing information associated with a SDU arriving at a PDCP layer of the UE 1202, the SDU associated with the UL data. Furthermore, 1614 may be performed by the timing information identifying component 1842.

At 1620, the base station may calculate an UL delay based at least in part on the timing information from the UE. The timing information may include at least one of an arrival time associated with the arrival of the SDU at the PDCP layer, a transmission time that the first MAC PDU containing the UL data of the SDU is transmitted to the base station, a header time associated with building the PDCP PDU header, a first time difference between the arrival time and the transmission time, or a third time difference between the arrival time and the header time. For example, at 1220, the base station 1204 may calculate an UL delay based at least in part on the timing information from the UE 1202. Furthermore, 1620 may be performed by the UL delay calculation component 1844.

In one aspect, the UL delay may be calculated between the arrival time and the receive time. The timing information received from the UE may include the arrival time (SFN_s, SN_s), indicating the arrival time that the SDU arrive at the PDCP layer of the UE, where SFN_s is a system frame number and SN_s is a slot number of the system time that the SDU arrived at the PDCP layer of the UE from the higher layer of the UE. The base station may calculate the UL delay from the arrival time (SFN_s, SN_s) to the receive time (SFN_rx, SN_rx). Accordingly, the UL delay may be calculated as (SFN_rx, SN_rx)−(SFN_s, SN_s).

In another aspect, the UL delay may be calculated based on a first time difference and a second time difference, where the first time difference, e.g., the first wait time T_Wait, being between an arrival time associated with an arrival of the SDU at the PDCP layer of the UE and a transmission time when the UE transmitted, to the base station, a first MAC PDU containing the UL data of the SDU, and the second time difference, T_Air. That is, the base station may calculate the UL delay as the sum of the first time difference T_Wait and the second time difference T_Air calculated as (SFN_rx, SN_rx)−(SFN_tx, SN_tx) at 1616, e.g., T_Wait+(SFN_rx, SN_rx)−(SFN_tx, SN_tx).

In another aspect, the UL delay is calculated based on the third time difference and the fourth time difference, where the third time difference, e.g., the second wait time T_Wait_2, being between an arrival time associated with the arrival of the SDU at the PDCP layer and a time associated with building the PDCP PDU header, and the fourth time difference, T_Air_2. That is, the base station may calculate the UL delay as the sum of the third difference T_Wait_2 and the fourth time difference T_Air_2 calculated as (SFN_rx, SN_rx)−(SFN_he, SN_he), e.g., T_Wait_2+(SFN_rx, SN_rx)−(SFN_he, SN_he).

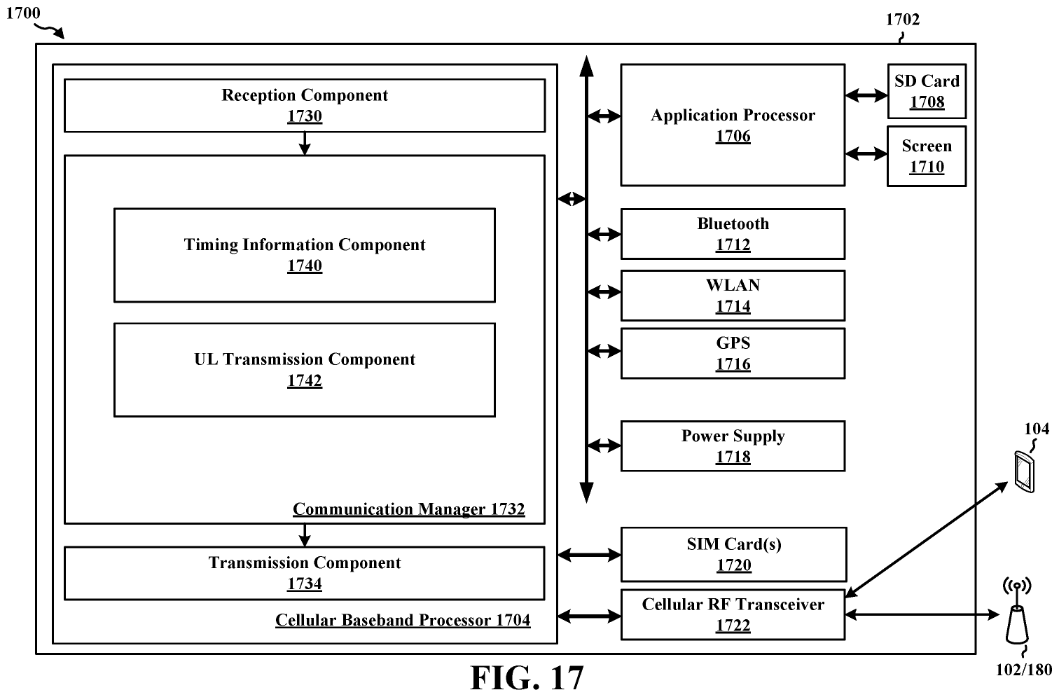

FIG. 17 is a diagram 1700 illustrating an example of a hardware implementation for an apparatus 1702. The apparatus 1702 may be a UE, a component of a UE, or may implement UE functionality. In some aspects, the apparatus 1702 may include a cellular baseband processor 1704 (also referred to as a modem) coupled to a cellular RF transceiver 1722. In some aspects, the apparatus 1702 may further include one or more subscriber identity modules (SIM) cards 1720, an application processor 1706 coupled to a secure digital (SD) card 1708 and a screen 1710, a Bluetooth module 1712, a wireless local area network (WLAN) module 1714, a Global Positioning System (GPS) module 1716, or a power supply 1718. The cellular baseband processor 1704 communicates through the cellular RF transceiver 1722 with the UE 108 and/or BS 102/180. The cellular baseband processor 1704 may include a computer-readable medium/memory. The computer-readable medium/memory may be non-transitory. The cellular baseband processor 1704 is responsible for general processing, including the execution of software stored on the computer-readable medium/memory. The software, when executed by the cellular baseband processor 1704, causes the cellular baseband processor 1704 to perform the various functions described supra. The computer-readable medium/memory may also be used for storing data that is manipulated by the cellular baseband processor 1704 when executing software. The cellular baseband processor 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the cellular baseband processor 1704. The cellular baseband processor 1704 may be a component of the UE 350 and may include the memory 360 and/or at least one of the TX processor 368, the RX processor 356, and the controller/processor 359. In one configuration, the apparatus 1702 may be a modem chip and include just the baseband processor 1704, and in another configuration, the apparatus 1702 may be the entire UE (e.g., see 350 of FIG. 3) and include the additional modules of the apparatus 1702.

The communication manager 1732 includes a timing information component 1740 that is configured to receive a SDU at a PDCP layer, and compare the first time difference to a threshold value, e.g., as described in connection with 1306, 1308, and 1406. The communication manager 1732 includes an UL transmission component 1742 that is configured to transmit at least one UL transmission including the UL data and timing information associated with an arrival of the SDU at the PDCP layer, e.g., as described in connection with 1310 and 1410.

The apparatus may include additional components that perform each of the blocks of the algorithm in the flowcharts of FIGS. 5, 6, 7, 8, 9, 10, 11, 12, 13, and 14. As such, each block in the flowcharts of FIGS. 5, 6, 7, 8, 9, 10, 11, 12, 13, and 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1702 may include a variety of components configured for various functions. In one configuration, the apparatus 1702, and in particular the cellular baseband processor 1704, includes means for means for receiving a SDU at a PDCP layer, the SDU including UL data to be transmitted in a PDU, means for comparing the first time difference to a threshold value, and means for transmitting, to a base station, at least one UL transmission including the UL data and timing information associated with an arrival of the SDU at the PDCP layer. The means may be one or more of the components of the apparatus 1702 configured to perform the functions recited by the means. As described supra, the apparatus 1702 may include the TX Processor 368, the RX Processor 356, and the controller/processor 359. As such, in one configuration, the means may be the TX Processor 368, the RX Processor 356, and the controller/processor 359 configured to perform the functions recited by the means.

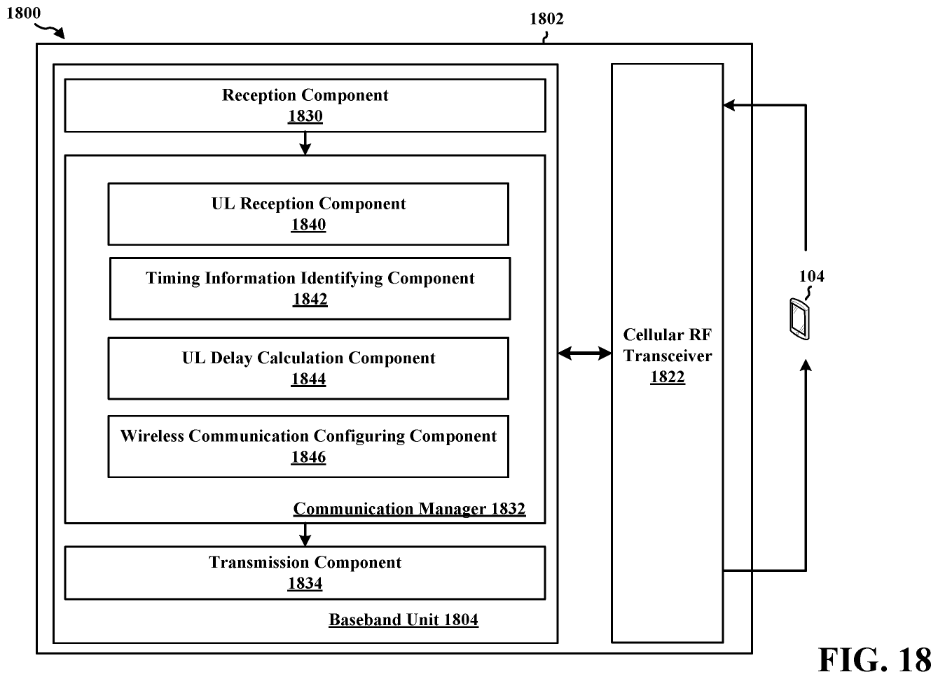

FIG. 18 is a diagram 1800 illustrating an example of a hardware implementation for an apparatus 1802. The apparatus 1802 may be a base station, a component of a base station, or may implement base station functionality. In some aspects, the apparatus 1702 may include a baseband unit 1804. The baseband unit 1804 may communicate through a cellular RF transceiver 1822 with the UE 108. The baseband unit 1804 may include a computer-readable medium/memory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband unit 1804. The baseband unit 1804 may be a component of the base station 310 and may include the memory 376 and/or at least one of the TX processor 316, the RX processor 370, and the controller/processor 375.

The communication manager 1832 includes an UL reception component 1840 configured to receive at least one UL transmission including an UL data e.g., as described in connection with 1510 and 1610. The communication manager 1832 includes a timing information identifying component 1842 configured to identify a receive time associated with successfully receiving the last MAC PDU associated with the UL data, and identify timing information associated with a SDU arriving at a PDCP layer of the UE, e.g., as described in connection with 1512, 1514, and 1614. The communication manager 1832 includes an UL delay calculation component 1844 configured to calculate a second time difference, a fourth time difference, and an UL delay based at least in part on the timing information from the UE, e.g., as described in connection with 1516, 1518, 1520, and 1620. The communication manager 1832 includes a wireless communication configuring component 1846 configured to manage UL resources allocated for the UL data or schedule DL transmission associated with the UL data based on the UL delay, e.g., as described in connection with 1522 and 1524.

The apparatus may include additional components that perform each of the blocks of the algorithm in the flowcharts of FIGS. 5, 6, 7, 8, 9, 10, 11, 12, 15, and 16. As such, each block in the flowcharts of FIGS. 5, 6, 7, 8, 9, 10, 11, 12, 15, and 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the baseband unit 1804, includes means for means for receiving, from a UE, at least one UL transmission including a UL data, means for identifying timing information associated with a SDU arriving at a PDCP layer of the UE, the SDU associated with the UL data, and means for calculating a UL delay based at least in part on the timing information from the UE. The apparatus 1802 includes means for managing UL resources allocated for the UL data based on the UL delay, and means for scheduling DL transmission associated with the UL data based on the UL delay. The apparatus 1802 includes means for identifying a receive time associated with successfully receiving, from the UE, a last MAC PDU associated with the UL data, wherein the UL delay is further based on the receive time, means for calculating a second time difference between the transmission time and the receive time, means for calculating a second time difference between the transmission time and the receive time, and means for calculating a fourth time difference between the time associated with building the PDCP PDU header and the receive time. The means may be one or more of the components of the apparatus 1802 configured to perform the functions recited by the means. As described supra, the apparatus 1802 may include the TX Processor 316, the RX Processor 370, and the controller/processor 375. As such, in one configuration, the means may be the TX Processor 316, the RX Processor 370, and the controller/processor 375 configured to perform the functions recited by the means.

In some aspects, a UE may receive, at a PDCP layer, a SDU including UL data to be transmitted to a base station, and transmit, to the base station, at least one UL transmission including the UL data and timing information associated with an arrival of the SDU at the PDCP layer. The base station may receive the at least one UL transmission including the UL data, identify timing information, and calculate an UL delay based at least in part on the timing information from the UE. The timing information may be communicated in at least one of a PDCP PDU header or a MAC-CE. The timing information may include at least one of, but not limited to, an arrival time associated with the arrival of the SDU at the PDCP layer, a transmission time associated with transmitting a first MAC PDU containing UL data of the SDU, a first wait time between an arrival time associated with the arrival of the SDU at the PDCP layer and the transmission time, or a second wait time between the arrival time associated with the arrival of the SDU at the PDCP layer and a time associated with building the PDCP PDU header.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to receive a SDU at a PDCP layer, the SDU including UL data to be transmitted in a PDU, and transmit, to a base station, at least one UL transmission including the UL data and timing information associated with an arrival of the SDU at the PDCP layer.

Aspect 2 is the apparatus of aspect 1, where the timing information is transmitted in a PDCP PDU header associated with the at least one UL transmission.

Aspect 3 is the apparatus of any of aspect 2, where the timing information includes an arrival time associated with the arrival of the SDU at the PDCP layer.

Aspect 4 is the apparatus of any of aspect 3, where the timing information includes one or more of a SFN and a SN for the arrival of the SDU at the PDCP layer.

Aspect 5 is the apparatus of any of aspect 2, where the timing information includes a first time difference between an arrival time associated with the arrival of the SDU at the PDCP layer and a transmission time associated with transmitting, to the base station, a first MAC PDU containing UL data of the SDU.

Aspect 6 is the apparatus of any of aspect 5, where the timing information further includes the transmission time, and the transmission time is indicated in a MAC-CE.

Aspect 7 is the apparatus of any of aspect 2, where the timing information includes a third time difference between the arrival time associated with the arrival of the SDU at the PDCP layer and a time associated with building the PDCP PDU header.

Aspect 8 is the apparatus of any of aspects 1 to 7, where the timing information is transmitted in a MAC-CE associated with the at least one UL transmission.

Aspect 9 is the apparatus of any of aspect 8, where the timing information is included in a buffer status report.

Aspect 10 is the apparatus of any of aspects 8 and 9, where the timing information includes a first time difference between an arrival time associated with the arrival of the SDU at the PDCP layer and a transmission time that a first MAC PDU containing UL data of the SDU is transmitted to the base station.

Aspect 11 is the apparatus of any of aspects 10, where the at least one processor is further configured to compare the first time difference to a threshold value, and the timing information is transmitted based on the first time difference being greater than or equal to the threshold value.

Aspect 12 is the apparatus of any of aspects 10 and 11, where the timing information further includes the transmission time that the first MAC PDU containing the UL data of the SDU is transmitted to the base station.

Aspect 13 is a method of wireless communication for implementing any of aspects 1 to 12.

Aspect 14 is an apparatus for wireless communication including means for implementing any of aspects 1 to 12.

Aspect 15 is a computer-readable medium storing computer executable code, where the code when executed by a processor causes the processor to implement any of aspects 1 to 12.

Aspect 16 is an apparatus for wireless communication including at least one processor coupled to a memory and configured to receive, from a UE, at least one UL transmission including an UL data, identify timing information associated with a SDU arriving at a PDCP layer of the UE, the SDU associated with the UL data, and calculate an UL delay based at least in part on the timing information from the UE.

Aspect 17 is the apparatus of aspect 16, where the at least one processor is further configured to identify a receive time associated with successfully receiving, from the UE, the last MAC PDU associated with the UL data, where the UL delay is further based on the receive time.

Aspect 18 is the apparatus of any of aspects 16 and 17, where the at least one processor is further configured to manage UL resources allocated for the UL data based on the UL delay.

Aspect 19 is the apparatus of any of aspects 16 to 18, where the at least one processor is further configured to schedule DL transmission associated with the UL data based on the UL delay.

Aspect 20 is the apparatus of any of aspects 16 to 19, where the timing information is received in a PDCP PDU header associated with the at least one UL transmission.

Aspect 21 is the apparatus of any of aspect 20, where the timing information includes a first arrival time associated with an arrival of the SDU at the PDCP layer of the UE.

Aspect 22 is the apparatus of any of aspect 21, where the UL delay is calculated between the arrival time and the receive time.

Aspect 23 is the apparatus of any of aspect 20, where the timing information includes a first time difference between an arrival time associated with an arrival of the SDU at the PDCP layer of the UE and a transmission time when the UE transmitted, to the base station, a first MAC PDU containing the UL data of the SDU.

Aspect 24 is the apparatus of any of aspect 23, where the at least one processor is further configured to calculate a second time difference between the transmission time and the receive time, and where the UL delay is calculated based on the first time difference and the second time difference.

Aspect 25 is the apparatus of any of aspect 23, where the timing information further includes the transmission time, and the transmission time is received in a MAC-CE.

Aspect 26 is the apparatus of any of aspect 25, where the at least one processor is further configured to calculate a second time difference between the transmission time and the receive time, and the UL delay is calculated based on the first time difference and the second time difference.

Aspect 27 is the apparatus of any of aspect 24, where the timing information includes a third time difference between an arrival time associated with the arrival of the SDU at the PDCP layer and a time associated with building the PDCP PDU header.

Aspect 28 is the apparatus of any of aspect 27, where the at least one processor is further configured to calculate a fourth time difference between the time associated with building the PDCP PDU header and the receive time, and the UL delay is calculated based on the third time difference and the fourth time difference.

Aspect 29 is the apparatus of any of aspects 16 to 28, where the timing information is included in a MAC-CE associated with the at least one UL transmission.

Aspect 30 is the apparatus of any of aspect 29, where the timing information includes a first time difference between an arrival time associated with an arrival of the SDU at the PDCP layer and a transmission time when a first MAC PDU containing the UL data of the SDU was transmitted to the base station.

Aspect 31 is the apparatus of any of aspect 30, where the timing information further includes the transmission time.

Aspect 32 is a method of wireless communication for implementing any of aspects 16 to 31.

Aspect 33 is an apparatus for wireless communication including means for implementing any of aspects 16 to 31.

Aspect 34 is a computer-readable medium storing computer executable code, where the code when executed by a processor causes the processor to implement any of aspects 16 to 31.

What is claimed is:

1. An apparatus for wireless communication at a UE, comprising:
a memory; and
at least one processor coupled to the memory and configured to:
receive a service data unit (SDU) at a packet data convergence protocol (PDCP) layer, the SDU including uplink (UL) data to be transmitted in a protocol data unit (PDU); and
transmit, to a base station, at least one UL transmission including the UL data and timing information associated with an arrival of the SDU at the PDCP layer.

2. The apparatus of claim 1, further comprising a transceiver coupled to the at least one processor,
wherein the timing information is transmitted in a PDCP PDU header associated with the at least one UL transmission.

3. The apparatus of claim 2, wherein the timing information includes an arrival time associated with the arrival of the SDU at the PDCP layer.

4. The apparatus of claim 3, wherein the timing information includes one or more of a system frame number (SFN) and a slot number (SN) for the arrival of the SDU at the PDCP layer.

5. The apparatus of claim 2, wherein the timing information includes a first time difference between an arrival time associated with the arrival of the SDU at the PDCP layer and a transmission time associated with transmitting, to the base station, a first medium access control (MAC) PDU containing UL data of the SDU.

6. The apparatus of claim 5, wherein the timing information further includes the transmission time, and the transmission time is indicated in a MAC control element (CE) (MAC-CE).

7. The apparatus of claim 2, wherein the timing information includes a third time difference between the arrival time associated with the arrival of the SDU at the PDCP layer and a time associated with building the PDCP PDU header.

8. The apparatus of claim 1, wherein the timing information is transmitted in a medium access control (MAC) control element (CE) (MAC-CE) associated with the at least one UL transmission.

9. The apparatus of claim 8, wherein the timing information is comprised in a buffer status report.

10. The apparatus of claim 8, wherein the timing information includes a first time difference between an arrival time associated with the arrival of the SDU at the PDCP layer and a transmission time that a first MAC PDU containing UL data of the SDU is transmitted to the base station.

11. The apparatus of claim 10, wherein the at least one processor is further configured to compare the first time difference to a threshold value, and
wherein the timing information is transmitted based on the first time difference being greater than or equal to the threshold value.

12. The apparatus of claim 10, wherein the timing information further includes the transmission time that the first MAC PDU containing the UL data of the SDU is transmitted to the base station.

13. An apparatus for wireless communication at a base station, comprising:
a memory; and
at least one processor coupled to the memory and configured to:
receive, from a user equipment (UE), at least one uplink (UL) transmission including an UL data;
identify timing information associated with a service data unit (SDU) arriving at a packet data convergence protocol (PDCP) layer of the UE, the SDU associated with the UL data; and
calculate an UL delay based at least in part on the timing information from the UE.

14. The apparatus of claim 13, further comprising a transceiver coupled to the at least one processor, wherein the at least one processor is further configured to:
identify a receive time associated with successfully receiving, from the UE, a last medium access control (MAC) protocol data unit (PDU) associated with the UL data, wherein the UL delay is further based on the receive time.

15. The apparatus of claim 13, wherein the at least one processor is further configured to:
manage UL resources allocated for the UL data based on the UL delay.

16. The apparatus of claim 13, wherein the at least one processor is further configured to:
schedule downlink (DL) transmission associated with the UL data based on the UL delay.

17. The apparatus of claim 13, wherein the timing information is received in a PDCP PDU header associated with the at least one UL transmission.

18. The apparatus of claim 17, wherein the timing information includes a first arrival time associated with an arrival of the SDU at the PDCP layer of the UE.

19. The apparatus of claim 18, wherein the UL delay is calculated between the arrival time and the receive time.

20. The apparatus of claim 17, wherein the timing information includes a first time difference between an arrival time associated with an arrival of the SDU at the PDCP layer of the UE and a transmission time when the UE transmitted, to the base station, a first medium access control (MAC) PDU containing the UL data of the SDU.

21. The apparatus of claim 20, wherein the at least one processor is further configured to calculate a second time difference between the transmission time and the receive time, and
wherein the UL delay is calculated based on the first time difference and the second time difference.

22. The apparatus of claim 20, wherein the timing information further includes the transmission time, and the transmission time is received in a MAC control element (CE) (MAC-CE).

23. The apparatus of claim 22, wherein the at least one processor is further configured to calculate a second time difference between the transmission time and the receive time, and
wherein the UL delay is calculated based on the first time difference and the second time difference.

24. The apparatus of claim 20, wherein the timing information includes a third time difference between an arrival time associated with the arrival of the SDU at the PDCP layer and a time associated with building the PDCP PDU header.

25. The apparatus of claim 24, wherein the at least one processor is further configured to calculate a fourth time difference between the time associated with building the PDCP PDU header and the receive time, and
wherein the UL delay is calculated based on the third time difference and the fourth time difference.

26. The apparatus of claim 13, wherein the timing information is comprised in a medium access control (MAC) control element (CE) (MAC-CE) associated with the at least one UL transmission.

27. The apparatus of claim 26, wherein the timing information includes a first time difference between an arrival time associated with an arrival of the SDU at the PDCP layer and a transmission time when a first MAC PDU containing the UL data of the SDU was transmitted to the base station.

28. The apparatus of claim 27, wherein the timing information further includes the transmission time.

29. A method of wireless communication at a user equipment (UE), comprising:
receiving a service data unit (SDU) at a packet data convergence protocol (PDCP) layer, the SDU including uplink (UL) data to be transmitted in a protocol data unit (PDU); and
transmitting to a base station, at least one UL transmission including the UL data and timing information associated with an arrival of the SDU at the PDCP layer.

30. A method of wireless communication at a base station, comprising:
receiving, from a user equipment (UE), at least one uplink (UL) transmission including an UL data;
identifying timing information associated with a service data unit (SDU) arriving at a packet data convergence protocol (PDCP) layer of the UE, the SDU associated with the UL data; and
calculating an UL delay based at least in part on the timing information from the UE.
